(19) United States
(12) Patent Application Publication
(10) Pub. No.: US 2025/0080777 A1
(43) Pub. Date: Mar. 6, 2025

(54) PAGE DISPLAY METHOD AND ELECTRONIC DEVICE

(71) Applicant: BEIJING DAJIA INTERNET INFORMATION TECHNOLOGY CO., LTD., Beijing (CN)

(72) Inventors: Yupeng LIU, Beijing (CN); Yuxiao HOU, Beijing (CN); Shoumin ZHANG, Beijing (CN)

(21) Appl. No.: 18/613,412

(22) Filed: Mar. 22, 2024

(30) Foreign Application Priority Data
Aug. 28, 2023 (CN) 202311091694.X

(51) Int. Cl. H04N 21/2187; H04N 21/4788

(52) U.S. Cl. CPC H04N 21/2187; H04N 21/4788

(57) ABSTRACT

A page display method is provided. The method includes: displaying, in a case that a second audience user gives a target virtual gift to an anchor user of a virtual live-streaming room, a virtual resource package associated with the target virtual gift on a live-streaming page of the virtual live-streaming room; generating a target comment in response to a trigger operation on the virtual resource package; and displaying the target comment sent by the first audience user on the live-streaming page.

This application is based on and claims priority to Chinese Patent Application No. 202311091694.X, filed on Aug. 28, 2023, the disclosure of which is herein incorporated by reference in its entirety.

### TECHNICAL FIELD

The present disclosure relates to the field of computer technologies, and in particular relates to a page display method and an electronic device.

### BACKGROUND

With the development of internet technologies, various functions are configured in live-streaming applications to increase the interaction between an anchor user and an audience user who watches the live streaming. For example, the audience user can give virtual gifts to the anchor user, send comments in the live-streaming room, and the like.

### SUMMARY

The present disclosure provides a page display method and an electronic device. The technical solutions are as follows.

According to a first aspect of the embodiments of the present disclosure, a page display method is provided. The page display method is performed by a first terminal on which a first audience user is currently logged in, and the method includes:
displaying, in a case that a second audience user gives a target virtual gift to an anchor user of a virtual live-streaming room, a virtual resource package associated with the target virtual gift on a live-streaming page of the virtual live-streaming room, wherein the second audience user is any audience user other than the first audience user in the virtual live-streaming room, the target virtual gift is any one of a plurality of virtual gifts of the virtual live-streaming room, and the anchor user is shown on the live-streaming page;
generating a target comment in response to a trigger operation on the virtual resource package, wherein the target comment includes an initial comment and user information of the second audience user, the initial comment is any comment in a comment library, and the comment library includes a plurality of comments having different contents; and
displaying the target comment sent by the first audience user on the live-streaming page.

According to a second aspect of the embodiments of the present disclosure, a page display method is provided. The page display method is performed by a second terminal on which a second audience user is currently logged in, and the method includes:
determining, in response to a gift-giving operation of the second audience user to an anchor user of a virtual live-streaming room, a virtual gift associated with the gift-giving operation;
generating a virtual resource package associated with the virtual gift based on a target virtual resource corresponding to the virtual gift, wherein the target virtual resource is a virtual resource spent by the second audience user on sending the virtual gift, and an amount of virtual resources included in the virtual resource package are positively correlated with the target virtual resource;
displaying the virtual resource package on a live-streaming page of the virtual live-streaming room, wherein the virtual resource package is configured to, upon being triggered, display a target comment sent by a first audience user on the live-streaming page, and the first audience user is any audience user other than the second audience user in the virtual live-streaming room; and
displaying a thank-you message on the live-streaming page in a case that a number of the target comments is greater than a quantity threshold.

According to a third aspect of the embodiments of the present disclosure, a page display apparatus is provided. The page display apparatus is performed by a first terminal on which a first audience user is currently logged in, and the page display apparatus includes:
a first display unit, configured to display, in a case that a second audience user gives a target virtual gift to an anchor user of a virtual live-streaming room, a virtual resource package associated with the target virtual gift on a live-streaming page of the virtual live-streaming room, wherein the second audience user is any audience user other than the first audience user in the virtual live-streaming room, the target virtual gift is any one of a plurality of virtual gifts of the virtual live-streaming room, and the anchor user is shown on the live-streaming page;
a first generation unit, configured to generate a target comment in response to a trigger operation on the virtual resource package, wherein the target comment includes an initial comment and user information of the second audience user, the initial comment is any comment in a comment library, and the comment library includes a plurality of comments having different contents; and
the first display unit is further configured to displaying the target comment sent by the first audience user on the live-streaming page.

According to a fourth aspect of the embodiments of the present disclosure, a page display apparatus is provided. The page display apparatus is performed by a second terminal on which a second audience user is currently logged in, and the page display apparatus includes:
a determining unit, configured to determine, in response to a gift-giving operation of the second audience user to an anchor user of a virtual live-streaming room, a virtual gift associated with the gift-giving operation;
a generation unit, configured to generate a virtual resource package associated with the virtual gift based on a target virtual resource corresponding to the virtual gift, wherein the target virtual resource is a virtual resource spent by the second audience user on sending the virtual gift, and an amount of virtual resources included in the virtual resource package are positively correlated with the target virtual resource;
a display unit, configured to display the virtual resource package on a live-streaming page of the virtual live-streaming room, wherein the virtual resource package is configured to, upon being triggered, display a target comment sent by a first audience user on the live-streaming page, and the first audience user is any audience user other than the second audience user in the virtual live-streaming room; and
the display unit is further configured to display a thank-you message on the live-streaming page in a case that a number of the target comments is greater than a quantity threshold.

According to a fifth aspect of the embodiments of the present disclosure, an electronic device is provided. The electronic device includes:
one or more processors; and
a memory configured to store program codes executable by the one or more processors;
wherein the one or more processors are configured to execute the program codes to implement following steps:
displaying, in a case that a second audience user gives a target virtual gift to an anchor user of a virtual live-streaming room, a virtual resource package associated with the target virtual gift on a live-streaming page of the virtual live-streaming room, wherein the second audience user is any audience user other than the first audience user in the virtual live-streaming room, the target virtual gift is any one of a plurality of virtual gifts of the virtual live-streaming room, and the anchor user is shown on the live-streaming page;
generating a target comment in response to a trigger operation on the virtual resource package, wherein the target comment includes an initial comment and user information of the second audience user, the initial comment is any comment in a comment library, and the comment library includes a plurality of comments having different contents; and
displaying the target comment sent by the first audience user on the live-streaming page.

According to a sixth aspect of the embodiments of the present disclosure, an electronic device is provided. The electronic device includes:
one or more processors; and
a memory configured to store program codes executable by the one or more processors;
wherein the one or more processors are configured to execute the program codes to implement following steps:
determining, in response to a gift-giving operation of a second audience user to an anchor user of a virtual live-streaming room, a virtual gift associated with the gift-giving operation;
generating a virtual resource package associated with the virtual gift based on a target virtual resource corresponding to the virtual gift, wherein the target virtual resource is a virtual resource spent by the second audience user on sending the virtual gift, and an amount of virtual resources included in the virtual resource package are positively correlated with the target virtual resource;
displaying the virtual resource package on the live-streaming page of the virtual live-streaming room, wherein the virtual resource package is configured to, upon being triggered, display a target comment sent by a first audience user on the live-streaming page, and the first audience user is any audience user other than the second audience user in the virtual live-streaming room; and
displaying a message of thanks on the live-streaming page in a case that a number of the target comments is greater than a quantity threshold.

According to a seventh aspect of the embodiments of the present disclosure, a computer-readable storage medium is provided. Program codes in the computer-readable storage medium, when executed by a processor of an electronic device, are caused to perform following steps:
displaying, in a case that a second audience user gives a target virtual gift to an anchor user of a virtual live-streaming room, a virtual resource package associated with the target virtual gift on a live-streaming page of the virtual live-streaming room, wherein the second audience user is any audience user other than the first audience user in the virtual live-streaming room, the target virtual gift is any one of a plurality of virtual gifts of the virtual live-streaming room, and the anchor user is shown on the live-streaming page;
generating a target comment in response to a trigger operation on the virtual resource package, wherein the target comment includes an initial comment and user information of the second audience user, the initial comment is any comment in a comment library, and the comment library includes a plurality of comments having different contents; and
displaying the target comment sent by the first audience user on the live-streaming page.

According to an eighth aspect of the embodiments of the present disclosure, a computer-readable storage medium is provided. Program codes in the computer-readable storage medium, when executed by a processor of an electronic device, are caused to perform following steps:
determining, in response to a gift-giving operation of a second audience user to an anchor user of a virtual live-streaming room, a virtual gift associated with the gift-giving operation;
generating a virtual resource package associated with the virtual gift based on a target virtual resource corresponding to the virtual gift, wherein the target virtual resource is a virtual resource spent by the second audience user on sending the virtual gift, and an amount of virtual resources included in the virtual resource package are positively correlated with the target virtual resource;
displaying the virtual resource package on the live-streaming page of the virtual live-streaming room, wherein the virtual resource package is configured to, upon being triggered, display a target comment sent by a first audience user on the live-streaming page, and the first audience user is any audience user other than the second audience user in the virtual live-streaming room; and
displaying a message of thanks on the live-streaming page in a case that a number of the target comments is greater than a quantity threshold.

According to a ninth aspect of the embodiments of the present disclosure, a computer program product including computer programs/instructions is provided. The computer programs/instructions, when executed by a processor, are caused to perform following steps:
displaying, in a case that a second audience user gives a target virtual gift to an anchor user of a virtual live-streaming room, a virtual resource package associated with the target virtual gift on a live-streaming page of the virtual live-streaming room, wherein the second audience user is any audience user other than the first audience user in the virtual live-streaming room, the target virtual gift is any one of a plurality of virtual gifts of the virtual live-streaming room, and the anchor user is shown on the live-streaming page;
generating a target comment in response to a trigger operation on the virtual resource package, wherein the target comment includes an initial comment and user information of the second audience user, the initial comment is any comment in a comment library, and the comment library includes a plurality of comments having different contents; and
displaying the target comment sent by the first audience user on the live-streaming page.

According to a tenth aspect of the embodiments of the present disclosure, a computer program product including computer programs/instructions is provided. The computer programs/instructions, when executed by a processor, are caused to perform following steps:
determining, in response to a gift-giving operation of a second audience user to an anchor user of a virtual live-streaming room, a virtual gift associated with the gift-giving operation;
generating a virtual resource package associated with the virtual gift based on a target virtual resource corresponding to the virtual gift, wherein the target virtual resource is a virtual resource spent by the second audience user on sending the virtual gift, and an amount of virtual resources included in the virtual resource package are positively correlated with the target virtual resource;
displaying the virtual resource package on the live-streaming page of the virtual live-streaming room, wherein the virtual resource package is configured to, upon being triggered, display a target comment sent by a first audience user on the live-streaming page, and the first audience user is any audience user other than the second audience user in the virtual live-streaming room; and
displaying a message of thanks on the live-streaming page in a case that a number of the target comments is greater than a quantity threshold.

### BRIEF DESCRIPTION OF DRAWINGS

The accompanying drawings, which are incorporated into the specification and constitute a part of the specification, illustrate the embodiments of the present disclosure and explain the principle of the present disclosure together with the specification, but do not limit the present disclosure.

FIG. 1 is a schematic diagram of an implementation environment according to some embodiments of the present disclosure;

FIG. 2 is a flowchart of a page display method according to some embodiments of the present disclosure;

FIG. 3 is a flowchart of another page display method according to some embodiments of the present disclosure;

FIG. 4 are schematic diagrams of live-streaming pages illustrating a virtual resource package according to some embodiments of the present disclosure;

FIG. 5 are schematic diagrams of live-streaming pages illustrating a target comment according to some embodiments of the present disclosure;

FIG. 6 are schematic diagrams of live-streaming pages illustrating a first gift interface according to some embodiments of the present disclosure;

FIG. 7 are schematic diagrams of live-streaming pages illustrating a second gift interface according to some embodiments of the present disclosure;

FIG. 8 are schematic diagrams of live-streaming pages illustrating a process of giving a virtual gift by a first audience user according to some embodiments of the present disclosure;

FIG. 9 are schematic diagrams live-streaming pages illustrating showing a prize draw result according to some embodiments of the present disclosure;

FIG. 10 is a schematic diagram showing a page display method according to some embodiments of the present disclosure;

FIG. 11 is a flowchart of still another page display method according to some embodiments of the present disclosure;

FIG. 12 is a block diagram of a page display apparatus according to some embodiments of the present disclosure;

FIG. 13 is a block diagram of another page display apparatus according to some embodiments of the present disclosure;

FIG. 14 is a block diagram of still another page display apparatus according to some embodiments of the present disclosure;

FIG. 15 is a block diagram of yet another page display apparatus according to some embodiments of the present disclosure; and

FIG. 16 is a block diagram of an electronic device according to some embodiments of the present disclosure.

### DETAILED DESCRIPTION

It should be noted that the information (including, but not limited to, user device information, user personal information, etc.), data (including, but not limited to, data used for analysis, stored data, displayed data, etc.), and signals involved in the present disclosure are all authorized by users or fully authorized by respective parties, and the collection, use and processing of the relevant data need to comply with relevant laws, regulations and standards of the respective countries and regions. For example, the user information and relationship information, etc. involved in the present disclosure are all obtained under full authorization.

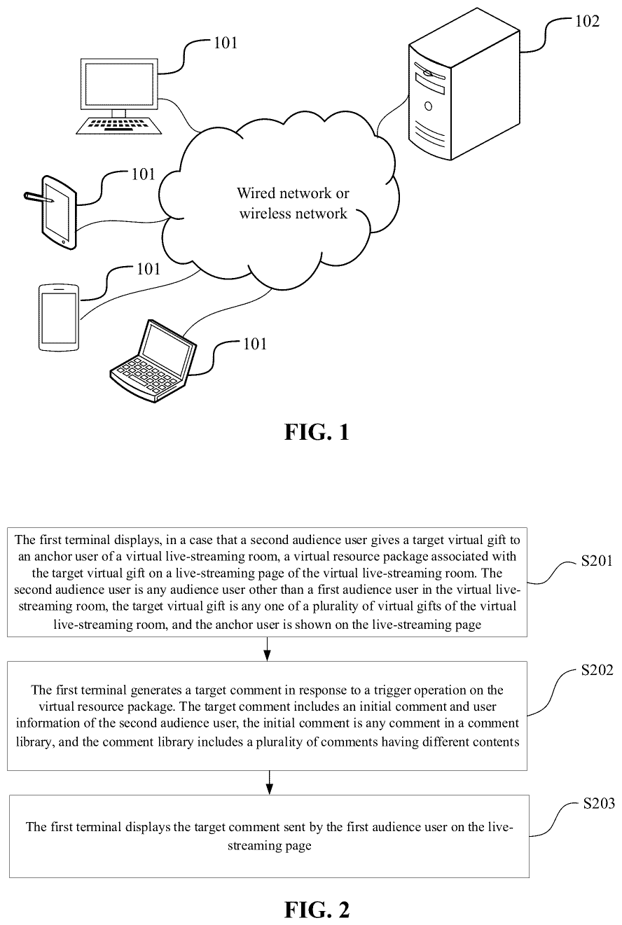

FIG. 1 is a schematic diagram of an implementation environment of a page display method according to some embodiments. Referring to FIG. 1, the implementation environment specifically includes: a terminal 101 and a server 102. The terminal 101 is connected to the server 102 via a wireless network or a wired network.

The terminal 101 may be an electronic device, and may be at least one of a smartphone, a smartwatch, a desktop computer, a laptop computer, a moving picture experts group audio layer III (MP3) player, a moving picture experts group audio layer IV (MP4) player and a laptop computer. A live-streaming application may be installed and run on the terminal 101, and a user may log into the live-streaming application through the terminal 101 to obtain the live-streaming service provided by the live-streaming application. Taking an example where the terminal 101 is a terminal used by an anchor user, the anchor user can create a virtual live-streaming room through the live-streaming application and display a live-streaming screen in the virtual live-streaming room. The audience user can view the live-streaming screen of the anchor user after entering the virtual live-streaming. The server 102 may be a backend server of the live-streaming application, and the server 102 is configured to provide backend services for the live-streaming application.

The terminal 101 generally refers to one of a plurality of terminals, and this embodiment is illustrated by taking the terminal 101 as an example. It will be appreciated by those skilled in the art that there may be more or fewer terminals, for example, there are several terminals, or there are dozens or hundreds of terminals, or there are more terminals. The number and the device type of the terminals are not limited in the embodiments of the present disclosure.

The server 102 is at least one of a server, a plurality of servers, a cloud computing platform, and a virtualization center. Optionally, there are more or fewer servers, which is not limited in the embodiments of the present disclosure. Certainly, the server 102 may also include other functional servers to provide more comprehensive and diverse services. In some embodiments, the server 102 undertakes the primary computing work and the terminal 101 undertakes the secondary computing work; or the server 102 undertakes the secondary computing work and the terminal 101 undertakes the primary computing work; or the server 102 and the terminal 101 carry out collaborative computing using a distributed computing architecture. The server 102 may be connected to the terminal 101 and other terminals via a wireless network or a wired network. Optionally, there are more or fewer servers, which is not limited in the embodiments of the present disclosure.

FIG. 2 is a flowchart of a page display method according to some embodiments of the present disclosure. Referring to FIG. 2, the method is implemented by a first terminal and includes the following steps.

In S201, the first terminal displays, in a case that a second audience user gives a target virtual gift to an anchor user of a virtual live-streaming room, a virtual resource package associated with the target virtual gift on a live-streaming page of the virtual live-streaming room. The second audience user is any audience user other than a first audience user in the virtual live-streaming room, the target virtual gift is any one of a plurality of virtual gifts of the virtual live-streaming room, and the anchor user is shown on the live-streaming page.

In the embodiments of the present disclosure, the first terminal is a terminal currently logged in by the first audience user, and a live-streaming application is installed and runs in the first terminal. The first audience user can browse a followed virtual live-streaming room or a recommended virtual live-streaming room on a live-streaming browsing page of the live-streaming application, and the first audience user can also search for a virtual live-streaming room through the live-streaming application and browse at least one searched virtual live-streaming room on the search result page. Accordingly, the first audience user can enter the virtual live-streaming room of the anchor user through the live-streaming application, and watch the live-streaming screen of the anchor user on the live-streaming page of the virtual live-streaming room. In the case that the second audience user in the virtual live-streaming room gives a target virtual gift to the anchor user, the first terminal can display a virtual resource package associated with the target virtual gift on the live-streaming page. The second audience user is any audience user other than the first audience user in the virtual live-streaming room, the target virtual gift is any one of a plurality of virtual gifts of the virtual live-streaming room, and the virtual resource package may be a virtual red envelope, a virtual coupon, or the like, which is not limited in the embodiments of the present disclosure. In an example, the act of the second audience user giving the target virtual gift to the anchor user triggers an red envelope lottery activity in the virtual live-streaming room, and each user in the virtual live-streaming room, including each of the first audience users, the anchor user and the second audience user, may participate in the red envelope lottery activity to win up to one of the virtual red envelopes associated with the target virtual gift by sending a particular comment in the virtual live-streaming room. In an example, the second audience user purchases, using virtual resource (such as live-streaming coins), the target virtual gift on the gift shop page of the virtual live-streaming room to give it to the anchor user of the virtual live-streaming room, and the quantity of the virtual red envelopes associated with the target virtual gift is shown in the gift description of the target virtual gift on the gift shop page.

In S202, the first terminal generates a target comment in response to a trigger operation, by the first audience user, on the virtual resource package. The target comment includes an initial comment and user information of the second audience user, the initial comment is any comment in a comment library, and the comment library includes a plurality of comments having different contents. For example, the initial comments may be greeting or blessing such as “wish all the best”, “career is successful all the way.” In other examples, the initial comments may be configured based on the types of virtual resources such as virtual red envelope and a virtual coupon, and different initial comments are available for generation when the types of virtual resource is detected. In still other examples, the initial comments may be configured based on the types of audience users such as an anonymous type or a public type, and different initial comments are available for generation when it is determined that the audience user is an anonymous type or a public type. The comment library may be stored in the live-streaming sever.

In the embodiments of the present disclosure, in the case that the first audience user triggers a virtual resource package displayed on the live-streaming page, it indicates that the first audience user wishes to participate in the activity of receiving the virtual resource package. The first terminal, in response to the trigger operation, can generate a target comment. The target comment includes the user information of the second audience user and a default initial comment. The user information may be a name, an avatar, a text introduction, and the like of the second audience user. The initial comment is any comment in the comment library, and the content of the initial comment is not limited in the embodiments of the present disclosure. Through generating the target comment, the first audience user can successfully participate in the activity of receiving the virtual resource package, and interact with the second audience user.

In S203, the first terminal displays the target comment sent by the first audience user on the live-streaming page.

In the embodiments of the present disclosure, after the first audience user triggers the virtual resource package, the first terminal can generate a target comment and automatically send the target comment to the virtual live-streaming room, that is, the first terminal displays the target comment sent by the first audience user on the live-streaming page of the virtual live-streaming room, such that the first audience user can interact with the second audience user while participating in the activity of receiving the virtual resource package. In some embodiments, the target comment is identified as a comment sent by the first audience user. For example, the first audience user may be identified by the user information. In another example, the first audience user may be identified as Audience B or Audience C such that the second audience user knows that the act of giving a target gift is responded by the audience in the live-streaming room.

In the related art, after an audience user sends a virtual gift, the information of the virtual gifts can be shown on a designated place for the gifts on the live-streaming page in a live-streaming room so that other audience users and the anchor user can see the situation of gift giving. However, for the plurality of audience users in the live-streaming room, the manners of interactions among them are limited. The embodiments of the present disclosure provide a page display method. According to this method, when the second audience user gives the target virtual gift to the anchor user of the virtual live-streaming room, the virtual resource package associated with the target virtual gift is displayed on the live-streaming page. After the first audience user triggers the virtual resource package, the first terminal can determine the target comment to be sent based on the user information of the second audience user and the initial comment in a comment library, and automatically send the target comment to the virtual live-streaming room. In this way, the audience user can automatically comment by triggering the virtual resource package, thereby achieving efficient interaction between audience users, which not only enriches the interaction mode between the audience users, but also simplifies the interaction path for receiving the virtual resource package. Thus, the participation efficiency of the audience users and the human-computer interaction efficiency are improved. According to the present disclosure, the chain interaction among multiple people in the live-streaming room is triggered by way of gift-giving, which improves the interactive display effect and display time of gifts, which can prolong the interactive effect in the live-streaming room by using gifts in the manner of a secondary special effect of one-key gift-giving, triggering the gift-giving by a second audience user to generate the resource package (the first special effect), clicking on the resource package by a first audience user to trigger automatic comments (the second special effect), which can result in multiple people's commenting to trigger gifts, thereby increasing other users' participation in the post-path operation brought by the gift-giving operation while enriching and prolonging the display effect of gift-giving, which is not achievable by the existing gift-giving.

In some embodiments, displaying the virtual resource package associated with the target virtual gift on the live-streaming page of the virtual live-streaming room in the case that the second audience user gives the target virtual gift to the anchor user of the virtual live-streaming room includes:
displaying a resource package entry of the virtual resource package on the live-streaming page of the virtual live-streaming room in the case that the second audience user gives the target virtual gift to the anchor user of the virtual live-streaming room; and
displaying the virtual resource package on the live-streaming page in response to a trigger operation on the resource package entry, wherein the user information of the second audience user and a participation control are displayed on the virtual resource package, and the participation control is configured to, upon being triggered, display the number of participants of the virtual resource package and a prize draw countdown on the virtual resource package.

In some embodiments, the first terminal displays a resource package entry of the virtual resource package associated with the target virtual gift on the live-streaming page in the case that the second audience user gives the target virtual gift to the anchor user, such that the first audience user can trigger the resource package entry to view the relevant information of the virtual resource package and the first terminal prompts the first audience user to participate the activity of receiving the virtual resource package, which increases the interest of watching the live streaming by the audience users, and improves the user experience of the audience users.

In some embodiments, generating the target comment in response to the trigger operation on the virtual resource package includes:
determining, in response to the trigger operation on the virtual resource package, a user type of the second audience user based on the user information of the second audience user, wherein the user type includes an anonymous type and a public type, the anonymous type indicates that the user information of the second audience user is displayed anonymously in the virtual live-streaming room, and the public type indicates that the user information of the second audience user is displayed publicly in the virtual live-streaming room;
generating the target comment based on the anonymous information of the second audience user and the initial comment in the case that the user type is the anonymous type;
generating the target comment based on a user name of the second audience user and the initial comment in the case that the user type is the public type.

In the embodiments of the present disclosure, by determining the user type of the second audience user, the first terminal can generate the target comment based on the anonymous information of the second audience user and the initial comment in the case that the user type is the anonymous type, thereby preventing the user information of the second audience user from leakage; and the first terminal can generate the target comment based on the user name of the second audience user and the initial comment in the case that the user type is the public type, thereby achieving the interaction between audience users, which enriches the interaction manners and improves the interaction efficiency between audience users. Thus, the human-computer interaction efficiency is improved.

In some embodiments, the method further includes:
displaying, in response to the number of participants of the virtual resource package being greater than a quantity threshold (for example, when the act of the second audience user giving the target virtual gift to the anchor user triggers an red envelope lottery activity in the virtual live-streaming room, the live-streaming server hosts this lottery activity, and the number of participants can be counted and compared with the quantity threshold by the live-streaming server), a thank-you message with an anonymous type in a first display type on the live-streaming page in the case that the user type of the second audience user is the anonymous type, wherein the first display type is obtained based on at least one of live-streaming information of the virtual live-streaming room and relationship information of the second audience user, the relationship information represents an association relationship between the second audience user and the anchor user, and the anonymous type indicates that the user information of the second audience user is displayed anonymously in the virtual live-streaming room; and
displaying a thank-you message with a public type in a second display type on the live-streaming page in the case that the user type of the second audience user is the public type, wherein the second display type is obtained based on the user information of the second audience user, and the public type indicates that the user information of the second audience user is displayed publicly in the virtual live-streaming room.

In the embodiments of the present disclosure, by determining the user type of the second audience user, the first terminal can display a thank-you message in a first display type based on the live-streaming information of the virtual live-streaming room or the relationship information of the second audience user in the case that the user type is the anonymous type, which can prevent the user information of the second audience user from leakage while thanking the second audience user; and the first terminal can display a thank-you message in a second display type based on the user information of the second audience user in the case that the user type is the public type, which can increases the interest of watching the live streaming by the audience users, and improves the user experience of the audience users.

In some embodiments, the method further includes:
displaying a first gift interface on the live-streaming page in response to a trigger operation on the thank-you message, wherein the plurality of virtual gifts and a first send control are displayed on the first gift interface, and the first send control is configured to, upon being triggered, send a virtual gift selected by the first audience user from the plurality of virtual gifts to the anchor user; and
displaying the target virtual gift of the plurality of virtual gifts in a selected state.

In the embodiments of the present disclosure, in the case that the first audience user triggers the thank-you message, the first terminal can prompt, by displaying the first gift interface, such that the first audience user to select a virtual gift that the first audience user wishes to give to the anchor user from the plurality of virtual gifts, which increases the interaction efficiency between the audience user and the anchor user, thereby increasing the human-computer interaction efficiency.

In some embodiments, the method further includes:
displaying a second gift interface on the live-streaming page in response to a trigger operation on the thank-you message, wherein gift details of the target virtual gift and a second send control are displayed on the second gift interface, and the second send control is configured to, upon being triggered, send the target virtual gift to the anchor user.

In the embodiments of the present disclosure, after the first audience user triggers the thank-you message, the first terminal can directly display the second gift interface for giving the target virtual gift to the anchor user, and the first audience user can give the virtual gift to the anchor user by triggering the second send control, without the need for the first audience user to manually select the virtual gift to be given from the plurality of virtual gifts. In this way, the efficiency of sending the virtual gifts, the human-computer interaction efficiency, and the user experience of the audience users are improved.

In some embodiments, the method further includes:
determining, in response to a gift-giving operation to the anchor user, the number of virtual gifts associated with the gift-giving operation and a target virtual resource, wherein the target virtual resource is a virtual resource spent by the first audience user on sending the virtual gifts (i.e., the virtual resource to be sent);
generating the virtual resource package associated with the virtual gifts based on the number of virtual gifts and the target virtual resource, wherein an amount of virtual resources included in the virtual resource package are positively correlated with the number of the virtual gifts and an amount of the target virtual resource; and
displaying the virtual resource package on the live-streaming page, wherein the virtual resource package displays the number of participants of the virtual resource package and a prize draw countdown.

In the embodiments of the present disclosure, by determining the number of the virtual gifts given by the second audience user and the virtual resource spent for each virtual gift, the first terminal can generate a virtual resource package based on part of the total virtual resources spent for giving the plurality of virtual gifts by the audience user, and other audience users in the live-streaming room can participate in the activity of receiving the virtual resource package, thereby achieving the interaction between the audience users, which enriches the interaction manners and improves the interaction efficiency between audience users. Thus, the human-computer interaction efficiency is improved.

In some embodiments, the method further includes:
displaying a resource package prompt message in a case that the first audience user is not in the virtual live-streaming room (this first audience user may be an audience user who is previewing several live-streaming rooms and has not yet entered any of them, for example), wherein the resource package prompt message is used to prompt the first audience user that a virtual resource package is being distributed in the virtual live-streaming room; and
displaying the live-streaming page of the virtual live-streaming room in response to a trigger operation on the resource package prompt message, wherein the virtual resource package is displayed on the live-streaming page.

In the embodiments of the present disclosure, in the case that a virtual resource package is being distributed in the virtual live-streaming room, if the first audience user is not in the virtual live-streaming room, the first terminal displays a prompt message, to prompt the first audience user that a virtual resource package is being distributed in the virtual live-streaming room, such that the first audience user can trigger the prompt message to automatically jump to the virtual live-streaming room to allow the first audience user to participate in the activity of receiving the virtual resource package.

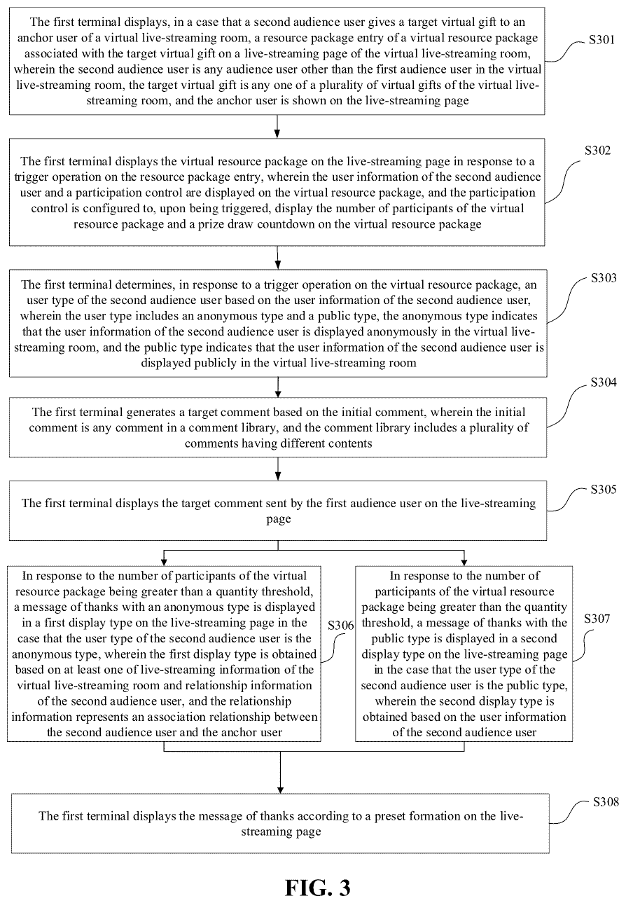

FIG. 2 above shows a flow of page display according to the present disclosure, and the page display solution according to the present disclosure is illustrated further below. FIG. 3 is a flowchart of another page display method according to some embodiments of the present disclosure, and this method is described by taking an example in which the method is performed by the first terminal. Referring to FIG. 3, the method includes the following.

In S301, the first terminal displays, in a case that a second audience user gives a target virtual gift to an anchor user of a virtual live-streaming room, a resource package entry of a virtual resource package associated with the target virtual gift on a live-streaming page of the virtual live-streaming room, wherein the second audience user is any audience user other than the first audience user in the virtual live-streaming room, the target virtual gift is any one of a plurality of virtual gifts of the virtual live-streaming room, and the anchor user is shown on the live-streaming page.

In the embodiments of the present disclosure, the first terminal is a terminal currently logged in by the first audience user, and a live-streaming application is installed and runs in the first terminal. The first audience user can browse a followed virtual live-streaming room or a recommended virtual live-streaming room on the live-streaming browsing page of the live-streaming application, and the first audience user can also search for a virtual live-streaming room through the live-streaming application and browse at least one searched virtual live-streaming room on the search result page. Accordingly, the first audience user can enter the virtual live-streaming room of the anchor user through the live-streaming application, and watch the live-streaming screen of the anchor user on the live-streaming page of the virtual live-streaming room. In the case that the second audience user in the virtual live-streaming room gives a target virtual gift to the anchor user, the first terminal can display the resource package entry of the virtual resource package associated with the target virtual gift on the live-streaming page, to allow the first audience user to trigger the resource package entry to view the virtual resource package triggered through sending the target virtual gift. The second audience user is any audience user other than the first audience user in the virtual live-streaming room, the target virtual gift is any one of a plurality of virtual gifts of the virtual live-streaming room, and the virtual resource package may be a virtual red envelope, a virtual coupon, or the like, which is not limited in the embodiments of the present disclosure. The resource package entry of the virtual resource package may be thumbnail icon of the virtual resource package.

In S302, the first terminal displays the virtual resource package on the live-streaming page in response to a trigger operation on the resource package entry, wherein the user information of the second audience user and a participation control are displayed on the virtual resource package, and the participation control is configured to, upon being triggered, display the number of participants of the virtual resource package and a prize draw countdown on the virtual resource package.

In the embodiments of the present disclosure, the first audience user triggers the resource package entry of the virtual resource package through a trigger operation. The first terminal can display, in response to the trigger operation, the virtual resource package on the live-streaming page to allow the first audience user to view information related to the virtual resource package triggered by sending the target virtual gift. The user information of the second audience user sending the target virtual gift and a participation control for participating in the activity of receiving the virtual resource package are displayed on the virtual resource package. The user information may be a name, an avatar, a text introduction, and the like of the second audience user. The first audience user can trigger the participation control to participate in the activity of receiving the virtual resource package, and meanwhile, the number of participants of the virtual resource package and a prize draw countdown can be displayed on the virtual resource package. In the case that the second audience user gives the target virtual gift to the anchor user through the first terminal, the first terminal displays the resource package entry of the virtual resource package associated with the target virtual gift on the live-streaming page, such that the first audience user can trigger the resource package entry to view the relevant information of the virtual resource package and the first terminal prompts the first audience user to participate the activity of receiving the virtual resource package, which increases the interest of watching the live streaming by the audience users, and improves the user experience of the audience users.

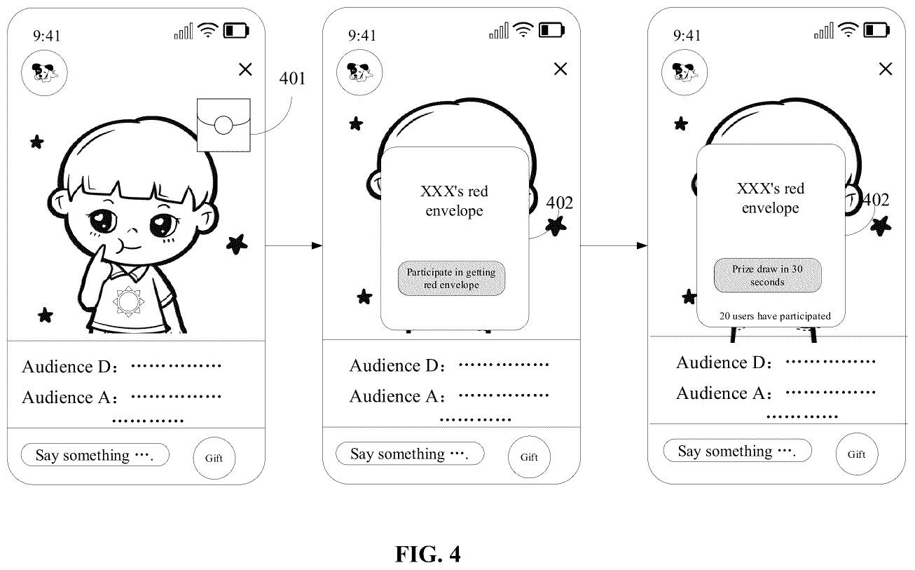

For example, FIG. 4 are schematic diagrams of live-streaming pages illustrating a virtual resource package according to some embodiments of the present disclosure. Referring to FIG. 4, by taking an example in which the virtual resource package sent by a second audience user XXX is a red envelope, a resource package entry 401 is displayed on the live-streaming page. When the first audience user triggers the resource package entry 401 (see the live-streaming page on the left), the first terminal displays a virtual resource package 402 on the live-streaming page. The user information of the second audience user, i.e., “XXX's red envelope”, and the participation control “participate in getting the red envelope” are displayed on the virtual resource package 402 (see the live-streaming page in the middle). When the first audience user triggers the participation control, the first terminal displays the number of participants of the virtual resource package 402, i.e., “20 users have participated” and the prize draw countdown, i.e., “Prize draw in 30 seconds” on the virtual resource package 402 (see the right live-streaming page on the right).

In S303, the first terminal determines, in response to a trigger operation on the virtual resource package, a user type of the second audience user based on the user information of the second audience user, wherein the user type includes an anonymous type and a public type, the anonymous type indicates that the user information of the second audience user is displayed anonymously in the virtual live-streaming room, and the public type indicates that the user information of the second audience user is displayed publicly in the virtual live-streaming room.

In the embodiments of the present disclosure, the second audience user is any audience user giving a target virtual gift to the anchor user other than the first audience user in the virtual live-streaming room. The user information of the second audience user may be information such as the name, avatar, text introduction of the second audience user. The first terminal determines that the user type of the second audience user is the anonymous type in the case that the user information of the second audience user is displayed anonymously in the virtual live-streaming room; conversely, the first terminal determines that the user type of the second audience user is the public type in the case that the user information of the second audience user is displayed publicly in the virtual live-streaming room.

In S304, the first terminal generates a target comment based on the initial comment, wherein the initial comment is any comment in a comment library, and the comment library includes a plurality of comments having different contents.

In the embodiments of the present disclosure, in the case that the user type is the anonymous type, the first terminal generates the target comment based on the anonymous information of the second audience user and the initial comment. In the case that the user type is the public type, the first terminal generates the target comment based on the user name of the second audience user and the initial comment. The target comment includes the initial comment and the user information of the second audience user.

In the case that the user type is the anonymous type, since the first terminal currently logged in by the first audience user cannot directly obtain the user information of the second audience user, the first terminal can determine the target comment to be sent to the virtual live-streaming room based on the anonymous information of the second audience and an initial comment randomly extracted from the comment library, such that the target comment indirectly includes the user information of the second audience user. The anonymous information includes information such as an anonymous name, an anonymous avatar of the second audience user. For example, the anonymous name may be a name that does not disclose the user information of the second audience user, such as a mystery man, an honored guest, an SVIP user, and the like. Conversely, in the case that the user type is the public type, since the first terminal currently logged in by the first audience user can directly obtain the user information of the second audience user, the first terminal can determine the target comment to be sent to the virtual live-streaming room based on the user information of the second audience user and an initial comment randomly selected from the comment library. By determining the user type of the second audience user, the first terminal can generate the target comment based on the anonymous information of the second audience user and the initial comment in the case that the user type is the anonymous type, thereby preventing the user information of the second audience user from leakage; and the first terminal can generate the target comment based on the user name of the second audience user and the initial comment in the case that the user type is the public type, thereby achieving the interaction between the audience users, which enriches the interaction manners and improves the interaction efficiency between audience users. Thus, the human-computer interaction efficiency is improved.

For example, the initial comment is “Get rich all the way” and the user name of the second audience user is “XX”. In the case that the user type of the second audience user is the anonymous type, the target comment may be “@mystery man, get rich all the way”. In the case that the user type of the second audience user is the public type, the target comment may be “@XX, get rich all the way”.

In S305, the first terminal displays the target comment sent by the first audience user on the live-streaming page.

In the embodiments of the present disclosure, after determining the target comment to be sent to the virtual live-streaming room, the first terminal can control the first audience user to automatically send the target comment to the virtual live-streaming room, and the first terminal can display the target comment on the live-streaming page of the virtual live-streaming room, without the need for the first audience user to manually input and send the comment. The target comment is directed to the second audience user and is identified as a comment from the first audience user. Since the target comment includes the user information of the second audience user, the first audience user actually interact with the second audience user while successfully participating in the activity of receiving the virtual resource package by sending the target comment, which enriches the interaction manner between the audience users, improves the interaction efficiency between the audience users. Thus, the human-computer interaction efficiency is improved.

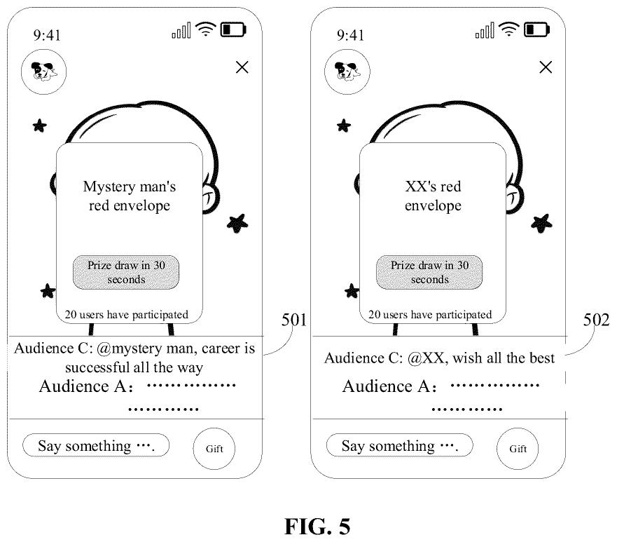

For example, FIG. 5 are schematic diagrams of live-streaming pages illustrating a target comment according to some embodiments. As shown in FIG. 5, a target comment is displayed on the live-streaming page, and “Audience C” is the first audience user and is identified as the first audience user who sends the target comment. In the case that the user type of the second audience user giving the target virtual gift is the anonymous type, the live-streaming page 501 displays the target comment sent by “Audience C” (i.e., the first audience user) as “@mystery man, career is successful all the way”. In the case that the user type of the second audience user is the public type, the live-streaming page 502 displays the target comment sent by “Audience C” as “@XX, wish all the best”.

Optionally, in response to the trigger operation on the target comment, the first terminal displays an information interface. The user information of the first audience user is displayed on the information interface. Other audience users in the virtual live-streaming room may also click on the target comment to view the user information of the first audience user. The information interface may be an information panel or an information pop-up window, which is not limited in the embodiments of the present disclosure.

In S306, in response to the number of participants of the virtual resource package being greater than a quantity threshold, a thank-you message with an anonymous type is displayed in a first display type on the live-streaming page in the case that the user type of the second audience user is the anonymous type, wherein the first display type is obtained based on at least one of live-streaming information of the virtual live-streaming room and relationship information of the second audience user, and the relationship information represents an association relationship between the second audience user and the anchor user. The thank-you message is configured to react to the degree of the participation in receiving the virtual resource package in the live-streaming room, and is stored in a message library. In some embodiments, a live-streaming server may determine the number of participants of the virtual resource package and send the determined number of the participants to the first terminal, and then the live-streaming server may determine whether the number of participants of the virtual resource package is greater than a quantity threshold.

In the embodiments of the present disclosure, the number of participants of the virtual resource package is the number of audience users participating in receiving the virtual resource package among the plurality of audience users of the virtual live-streaming room. In the case that the number of participants is greater than a quantity threshold, it indicates that there is a large of number of audience users participating in receiving the virtual resource package, and the first terminal can trigger a mechanism for displaying thank-you message configured to express gratitude to the gift-giving user (i.e., the second audience user) and/or compliment the gift-giving user. That is, the terminal can display the thank-you message on the live-streaming page. The thank-you message may be a special effect displayed in the form of a pop-up screen or a floating pop-up screen. The floating pop-up screen refers to a pop-up screen that is carried by a floating component on the virtual live-streaming room. The display type of the thank-you message is related to the user type of the gift-giving user, and therefore, the first terminal can determine the display type of the thank-you message based on the user type of the second audience user. The user type includes an anonymous type and a public type. In the case that the user type of the second audience user is the anonymous type, the first terminal can display the thank-you message with the anonymous type in the first display type on the live-streaming page. Since the anonymous type indicates that the user information of the second audience user is displayed anonymously in the virtual live-streaming room, the first terminal cannot directly obtain the user information of the second audience user. Therefore, the first terminal may obtain the live-streaming information of the virtual live-streaming room or the relationship information indicating the association relationship between the second audience user and the anchor user, and determine the first display type of the thank-you message based on at least one of the live-streaming information and the relationship information. The live-streaming information of the virtual live-streaming room may be a live-streaming name of the virtual live-streaming room, a user name of the anchor user of the virtual live-streaming room, or the like. The relationship information may be that the second audience user is a member of a fans club of the anchor user, or the second audience user is a member of a diamond fans club of the anchor user. The contents of the live-streaming information and the relationship information are not limited in the embodiments of the present disclosure. The first display type is used to indicate the display content of the thank-you message, and the display content includes at least one of the live-streaming information and the relationship information. Optionally, the contents of the thank-you message displayed in the first display type contain at least one of the live-streaming information and the relationship information.

In S307, in response to the number of participants of the virtual resource package being greater than the quantity threshold, a thank-you message with the public type is displayed in a second display type on the live-streaming page in the case that the user type of the second audience user is the public type, wherein the second display type is obtained based on the user information of the second audience user.

In the embodiments of the present disclosure, since the public type indicates that the user information of the second audience user is displayed publicly in the virtual live-streaming room, in the case that the user type of the second audience user is the public type, the first terminal currently logged in by the first audience user can directly obtain the user information of the second audience user and determine the second display type of the thank-you message based on the user information of the second audience user. The user information may be a name, an avatar, a text introduction, and the like of the second audience user. The second display type is used to indicate the display content of the thank-you message, and the display content includes the user information. Optionally, the contents of the thank-you message displayed in the second display type contain the user information.

In S308, the first terminal displays the thank-you message according to a preset formation on the live-streaming page.

In the embodiments of the present disclosure, after determining the thank-you message for thanking the second audience user, the first terminal can display the thank-you message on the live-streaming page according to a preset formation in the pop-up screen display mechanism. The preset formation may be in a V-shape, a pentagram shape, a wave shape, and the like. The second audience user can set the formation for displaying the thank-you message before the target virtual gift is given. Optionally, the first terminal can display the thank-you message in the form of a floating screen, which is a form of display by a display component floating on the screen. Each text in the thank-you message scrolls from left to right on the live-streaming page. By determining the user type of the second audience user, the first terminal can display the thank-you message in the first display type based on the live-streaming information of the virtual live-streaming room or the relationship information of the second audience user in the case that the user type is the anonymous type, which can prevent the user information of the second audience user from leakage while thanking the second audience user; and the first terminal can display the thank-you message in the second display type based on the user information of the second audience user in the case that the user type is the public type. In this way, the interestingness of watching the live streaming by the audience users is increased, and the user experience of the audience users is improved.

In some embodiments, for a plurality of messages of thanks to be displayed, the first terminal can display one thank-you message every M minute(s), and M is a positive integer. For any audience user, under a UA pair relationship (a correspondence between an audience user and an anchor user), the messages of thanks from the audience user appear at most Y times. The messages of thanks are at most displayed Z times in an hour in one virtual live-streaming room, wherein Y and Z are positive integers. Also, it should be noted that the first terminal does not display the thank-you message when a screen clearing operation is performed on the audience user side. Alternatively, the first terminal does not display the thank-you message when the anchor user turns off the gift special effect.

In addition, it should be noted that after the second audience user gives the target virtual gift to the anchor user, the first terminal can display two types of special effects in the virtual live-streaming room, including an instant special effect and a delayed special effect. The instant special effect is a gift special effect associated with the target virtual gift, and is triggered after the target virtual gift is given. In an example, the instant special effect includes an animation about falling red envelopes. The delayed special effect is a special effect displayed in the form of a pop-up screen, i.e., a thank-you message, and is triggered when the number of participants of the virtual resource package is greater than the quantity threshold. The first terminal displays these two types of special effects on the live-streaming page, which not only increases the interestingness of the users in watching the live streaming, but also enriches the interactivity of the users in giving gifts.

In some embodiments, the first audience user triggers the thank-you message, and then the first terminal can prompt the first audience user to give a gift to the anchor user in the first way and the second way below.

The first way: the first terminal prompts the first audience user to send any virtual gift to the anchor user. Accordingly, in response to the trigger operation on the thank-you message, the first terminal displays the first gift interface on the live-streaming page. The first gift interface may be a gift-giving panel or a gift-giving pop-up window, which is not limited in the embodiments of the present disclosure. A plurality of virtual gifts and a first send control are displayed on the first gift interface. The first send control is configured to, after being triggered, send the virtual gift selected by the first audience user from the plurality of virtual gifts to the anchor user. The virtual gift selected by the first audience user may be the target virtual gift or other virtual gifts. Since the thank-you message is a pop-up special effect for thanking the second audience user for sending the target virtual gift, after the first audience user triggers the thank-you message, the first terminal displays the target virtual gift of the plurality of virtual gifts displayed on the first gift interface in a selected state, and the first audience user can give the target virtual gift to the anchor user by triggering the first send control. Certainly, the first audience user may also select other virtual gifts and give the other virtual gifts to the anchor user by triggering the first send control. In the case that the first audience user triggers the thank-you message, the first terminal, by displaying the first gift interface, prompts the first audience user to select the virtual gift that the first audience user wishes to give to the anchor user from the plurality of virtual gifts, which increases the efficiency of the interaction between the audience user and the anchor user, and improves the human-computer interaction efficiency. In some examples, if the first audience user does not want to send the gift, he/she can click or touch a point outside the first gift interface on the live-streaming page and the first gift interface will disappear.

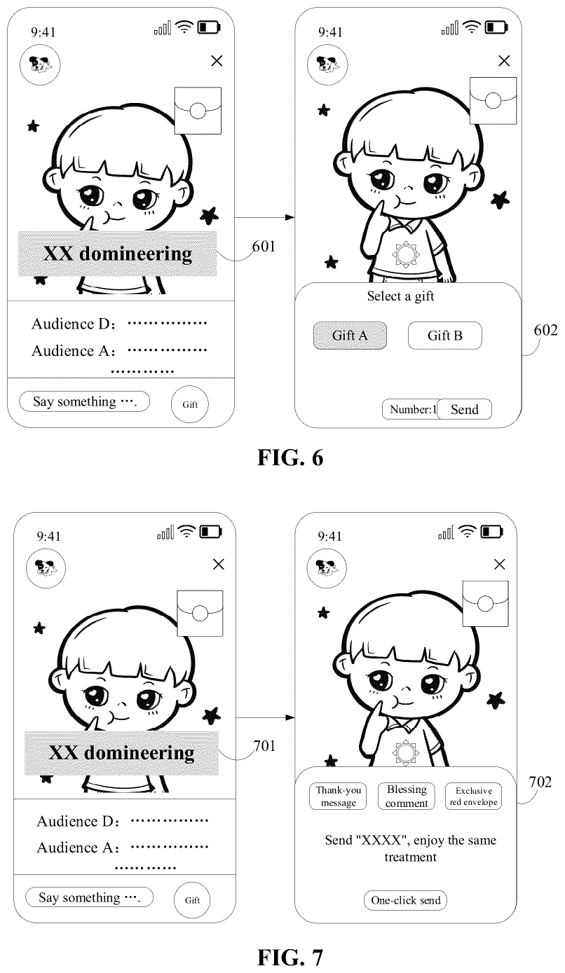

For example, FIG. 6 are schematic diagrams of live-streaming pages illustrating a first gift interface according to some embodiments. The live-streaming pages are displayed on a first terminal on which a first audience user is logged. As shown in FIG. 6, a thank-you message 601 is displayed on the live-streaming page, and the content of the thank-you message 601 is “XX domineering”. “XX” is a nickname of the second audience user or an honorific title for the second audience user, which is not limited in the embodiments of the present disclosure. The first audience user triggers the thank-you message 601, and then the first terminal displays the first gift interface 602 on the live-streaming page, which displays a plurality of virtual gifts, including a gift A and a gift B. The gift A is the target virtual gift, and the first terminal displays the gift A in a selected state. The first audience user may maintain the selected state of gift A or select the gift B. After the first audience user completes the selection, the first audience user may trigger the first send control “send” to give the selected virtual gift to the anchor user.

The second way: the first terminal prompts the first audience user to send the target virtual gift to the anchor user. Accordingly, in response to the trigger operation on the thank-you message, the first terminal displays a second gift interface on the live-streaming page. The second gift interface may be a gift-giving panel or a gift-giving pop-up window, which is not limited in the embodiments of the present disclosure. Gift details of the target virtual gift and a second send control are displayed on the second gift interface. The gift details include the special functions that can be triggered after the target virtual gift is given, such as displaying a virtual resource package, a thank-you message, etc. The second send control is configured to, after being triggered, send the target virtual gift to the anchor user. Since the thank-you message is a pop-up special effect for thanking the second audience user for sending the target virtual gift, after the first audience user triggers the thank-you message, the first terminal can directly display the second gift interface for giving the target virtual gift to the anchor user, and the first audience user can give the target virtual gift to the anchor user by triggering the second sending control, without the need for the first audience user to manually select the virtual gift to be given from the plurality of virtual gifts. In this way, the efficiency of sending the virtual gifts, the human-computer interaction efficiency, and the user experience of the audience users in watching the live streaming are improved. If the first audience user does not want to send the gift, he/she can click or touch a point outside the second gift interface on the live-streaming page and the second gift interface will disappear.

For example, FIG. 7 are schematic diagrams of live-streaming pages illustrating a second gift interface according to some embodiments. The live-streaming pages are displayed on a first terminal on which a first audience user is logged in. As shown in FIG. 7, a thank-you message 701 is displayed on the live-streaming page, and the content of the thank-you message 701 is “XX domineering”. “XX” may be a nickname of the second audience user or an honorific title for the second audience user, which is not limited in the embodiments of the present disclosure. The first audience user triggers the thank-you message 701, and then the first terminal displays the second gift interface 702 on the live-streaming page. The second gift interface 702 displays gift details of the target virtual gift “XXXX” and a second send control “one-click send”. The gift details include the special functions that can be triggered after the target virtual gift is given, such as “a message of thanks”, “blessing comment”, “exclusive red envelope”, etc. The first audience user can trigger the second send control to give the target virtual gift to the anchor user.

In some embodiments, the first audience user may also give a virtual gift to the anchor user and the terminal displays a virtual resource package associated with the virtual gift on the live-streaming page. Accordingly, in response to the gift-giving operation to the anchor user, the first terminal determines the number of the virtual gifts associated with the gift-giving operation and a target virtual resource. The target virtual resource is a virtual resource spent by the first audience user on sending the virtual gifts. The first terminal generates a virtual resource package associated with the virtual gift based on the number of the virtual gifts and the target virtual resource, and the an amount of virtual resources included in the virtual resource package are positively correlated with the number of the virtual gifts and an amount of the target virtual resource, for example, 1:1 relationship (i.e., one virtual resource package is generated for one virtual gift), or 2:1 relationship (i.e., one virtual resource package is generated for two virtual gifts) and so on. The first terminal displays the virtual resource packages on the live-streaming page, and the number of participants of the virtual resource package and a prize draw countdown are displayed on the virtual resource package. Optionally, after the response to the gift-giving operation to the anchor user, gift special effect information (such as an animation) corresponding to the gift is displayed. The gift-giving operation may be generated after the first audience user triggers the thank-you message, or may be generated after the first audience user triggers a gift-giving control on the live-streaming page, and the opportunity for the first audience user to trigger the gift-giving operation is not limited in the embodiments of the present disclosure. Before the first terminal displays the virtual resource package associated with the virtual gift corresponding to the gift-giving operation, the first terminal determines the virtual resources included in the virtual resource package to be generated based on the number of the virtual gifts that the first audience user gives to the anchor user and the virtual resource spent for sending one virtual gift, generates the virtual resource package associated with the first virtual gift and displays the virtual resource package on the live-streaming page. The virtual resources included in the virtual resource package are positively correlated with the number of the virtual gifts and the virtual resource spent for each virtual gift. The greater the number of the virtual resources, the more the total virtual resources spent by the first audience user on giving the plurality of virtual gifts, and the more the virtual resources included in the virtual resource package generated by the first terminal. By determining the number of the virtual gifts given by the second audience user and the virtual resource spent for each virtual gift, the first terminal can generate the virtual resource package based on part of the total virtual resources spent by the first audience user on giving the plurality of virtual gifts, to allow other audience users in the virtual live-streaming room to participate in the activity of reviving the virtual resource package, thereby achieving the interaction between the audience users, which enriches the interaction manners and improves the interaction efficiency between audience users. Thus, the human-computer interaction efficiency is improved.

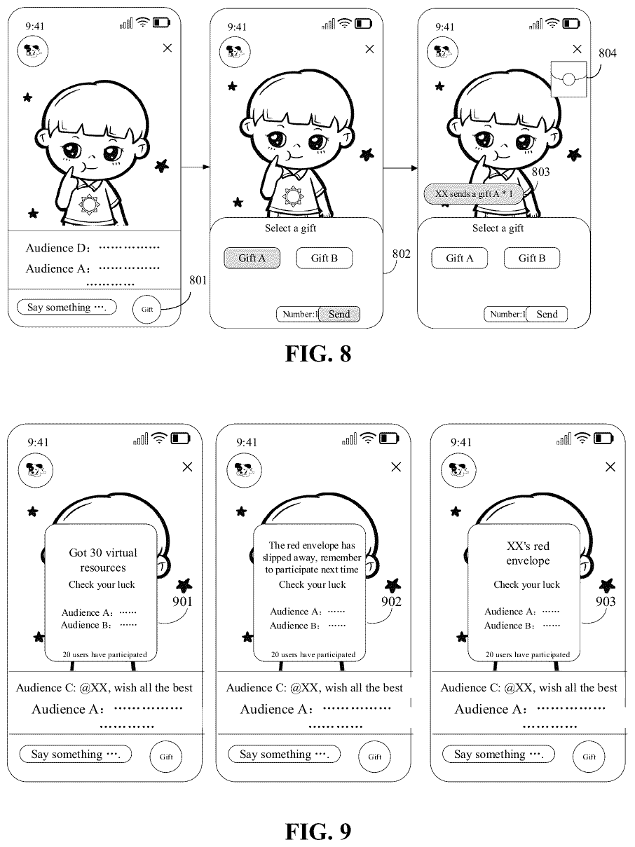

For example, FIG. 8 are schematic diagrams of live-streaming pages illustrating the process of giving a virtual gift by a first audience user according to some embodiments. As shown in FIG. 8, a gift-giving control 801 is displayed on the live-streaming page. The first audience user triggers the gift-giving control 801, and then the first terminal displays a third gift interface 802 on the live-streaming page. The third gift interface 802 may be a gift-giving panel or a gift-giving pop-up window, which is not limited in the embodiments of the present disclosure. The third gift interface 802 displays a plurality of virtual gifts, including gift A and gift B. The first audience user may select gift A, and give the virtual gift A to the anchor user by triggering the send control “send”. In response to the gift-giving operation of the first audience user to the anchor user, the first terminal displays gift-giving information 803 and a resource package entry 804 of the virtual resource package associated with the gift A on the live-streaming page. The gift-giving information 803 is “XX sent a gift Ax1”, representing that the first audience user (user name XX) has given a gift A to the anchor user.

In some embodiments, in response to the prize draw countdown being ended, the first terminal displays the prize draw result of the virtual resource package on the live-streaming page. The prize draw result indicates the receiving details of a plurality of audience users participating in receiving the virtual resource package. In the case that the first audience user is an audience user participating in receiving the virtual resource package, the prize draw result shows the receiving details of the first audience user and the receiving details of the other audience users. In the case that the first audience user is an audience user who does not participate in receiving the virtual resource package, the prize draw result does not show the receiving details of the first audience user. In the case that the first audience user is an audience user that gives a virtual gift, the prize draw result shows the receiving details of a plurality of audience users that participate in receiving the virtual resource package from the first audience user. If there is no participate, the prize draw result shows that no one has got the virtual resource package.

For example, FIG. 9 are schematic diagrams of live-streaming pages illustrating a prize draw result according to some embodiments. As shown in FIG. 9, in the case that the first audience user is an audience user participating in receiving the virtual resource package, the prize draw result 901 shows the receiving details of the first audience user, i.e., “Got 30 virtual resources” and the receiving details of other audience users (see the live-streaming page on the left). In the case that the first audience user is an audience user who does not participate in receiving the virtual resource package but is in the live-streaming room, the prize draw result 902 does not show the receiving details of the first audience user, and shows a prompt message “the red envelope has slipped away, remember to participate next time” (see the live-streaming page in the middle), which prompts the first audience user to participate in receiving the virtual resource package next time, and the receiving details of other audience users. In the case that the first audience user is an audience user that gives a virtual gift, the prize draw result 903 shows the receiving details of a plurality of audience users that participate in receiving the virtual resource package from the first audience user (see the live-streaming page on the right). For example, the prize draw result 903 shows that the red envelop is from XX (i.e., the first audience user), and “20 users have participated” among other information. It should be noted that the numbers “20” and “30” shown in FIG. 9 are examples to illustrate the number of virtual resources and the number of users who participates in the gift receiving activities in the live-streaming room. The numbers depend on the actual situation in the live-streaming room.

In some embodiments, in the case that the first audience user is in the live-streaming room but is participating in receiving the virtual gifts, the first terminal displays a resource package prompt message, and the resource package prompt message is used to prompt the first audience user that a virtual resource package is being distributed in the virtual live-streaming room. In response to a trigger operation on the resource package prompt message, the first terminal displays a live-streaming page of the virtual live-streaming room, and a virtual resource package is displayed on the live-streaming page. In the case that the virtual resource package is being distributed in the virtual live-streaming room, if the first audience user is not in the virtual live-streaming room, the first terminal displays the prompt message to prompt the first audience user that the virtual resource package is being distributed in the virtual live-streaming room, such that the first audience user may automatically jump to the virtual live-streaming room by triggering the prompt message to participate in receiving the virtual resource package. Optionally, the prompt message includes an avatar of the anchor user, a nickname of the anchor user, the prompt content “XX is distributing red envelopes, come and get the red envelopes to help me make it to the list!”, and a jump link of the virtual live-streaming room. “XX” may be a nickname of the second audience user or an honorific title for the second audience user, which is not limited in the embodiments of the present disclosure.

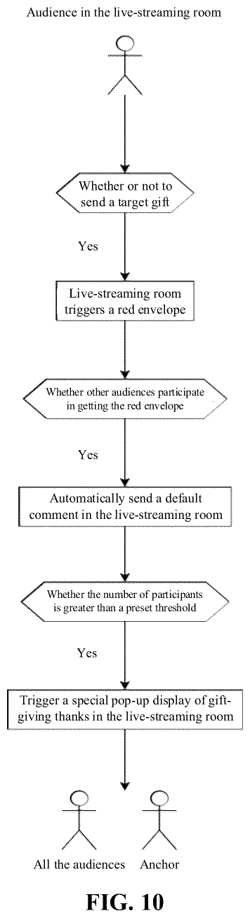

For example, FIG. 10 is a flow diagram of a page display method according to some embodiments. As shown in FIG. 10, by taking an example where the virtual resource package is a virtual red envelope, in the case that an audience user in the live-streaming room gives a target gift to the anchor, the virtual live-streaming room triggers red envelopes, that is, the first terminal (a terminal used by any user in the virtual live-streaming room and performs the steps in FIG. 10) displays the virtual red envelopes associated with the target gift on the live-streaming page of the virtual live-streaming room. In the case that other audience users in the virtual live-streaming room click to participate in getting the red envelopes, the first terminal currently logged in by first audience users can automatically send a default comment in the virtual live-streaming room, such that other audience users can successfully participate in the activity of getting the red envelopes. In the case that the number of people participating in getting the red envelopes is greater than a predetermined threshold, a special pop-up display of gift-giving thanks can be triggered in the live-streaming room, that is, the first terminal displays a thank-you message on the live-streaming page for all audiences and anchors in the live-streaming room to watch.

The embodiments of the present disclosure provide a page display method. According to this method, when the second audience user gives the target virtual gift to the anchor user of the virtual live-streaming room, the virtual resource package associated with the target virtual gift is displayed on the live-streaming page. In this way, after the first audience user triggers the virtual resource package, the first terminal can determine the target comment to be sent based on the user information of the second audience user and the initial comment, and automatically send the target comment to the virtual live-streaming room. The first audience user can automatically comment by triggering the virtual resource package, thereby achieving efficient interaction between audience users, which not only enriches the interaction mode between the audience users, but also simplifies the interaction path for receiving the virtual resource package. Thus, the participation efficiency of the audience users and the human-computer interaction efficiency are improved. According to the present disclosure, the first audience user may be multiple audience users in the live-streaming room, thus the chain interaction among multiple people in the live-streaming room is triggered by way of gift-giving and commenting on the gifts, which improves the interactive display effect and display time of gifts, which can prolong the interactive effect in the live-streaming room by using gifts in the manner of a secondary special effect of one-key gift-giving, triggering to generate the resource package, clicking on the resource package to trigger automatic comments, multiple people's commenting to trigger gifts, thereby increasing other users' participation in the post-path operation brought by the gift-giving operation while enriching and prolonging the display effect of gift-giving, which is not achievable by the existing gift-giving.

All of the above optional technical solutions may be combined in any manner to form the optional embodiments of the present disclosure, and details are not repeated herein.

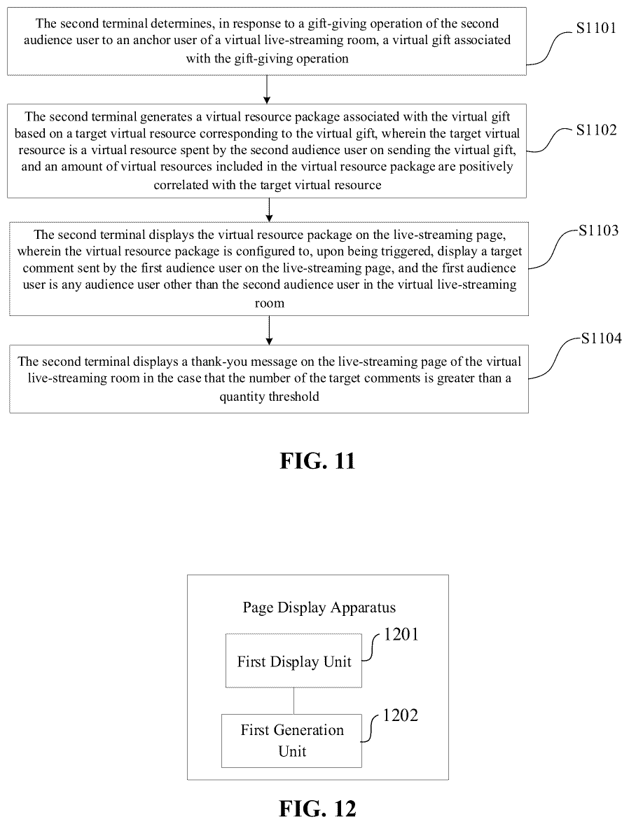

FIG. 11 is a flowchart of still another page display method according to some embodiments. Referring to FIG. 11, the method is implemented by a second terminal and include the following.

In S1101, the second terminal determines, in response to a gift-giving operation of the second audience user to an anchor user of a virtual live-streaming room, a virtual gift associated with the gift-giving operation.

In the embodiments of the present disclosure, the second terminal is a terminal currently logged in by the second audience user, and a live-streaming application is installed and runs in the second terminal. The second audience user can browse a followed virtual live-streaming room or a recommended virtual live-streaming room on the live-streaming browsing page of the live-streaming application, and the second audience user can also search for a virtual live streaming through the live-streaming application and browse at least one searched virtual live streaming on the search result page. Accordingly, the second audience user can enter the virtual live-streaming room of the anchor user through the live-streaming application, and watch the live-streaming screen of the anchor user on the live-streaming page of the virtual live-streaming room. In the case that the second audience user gives a target virtual gift to the anchor user, the second terminal can determine the virtual gift that the second audience user gives. Accordingly, the second terminal determines, in response to the gift-giving operation of the second audience user to the anchor user, the virtual gift associated with the gift-giving operation.

In S1102, the second terminal generates a virtual resource package associated with the virtual gift based on a target virtual resource corresponding to the virtual gift, wherein the target virtual resource is a virtual resource spent by the second audience user on sending the virtual gift, and an amount of virtual resources included in the virtual resource package are positively correlated with the target virtual resource.

In the embodiments of the present disclosure, since the target virtual resource is the virtual resource spent by the second audience user on sending the virtual gift, the second terminal determines the virtual resources included in the virtual resource package to be generated based on the virtual resource spent by the second audience user on giving the virtual gift to the anchor user, and then generate the virtual resource package associated with the virtual gift and display the virtual resource package on the live-streaming page. The virtual resources in the virtual resource package are positively correlated with the target virtual resource. The more the virtual resources the second audience user spends on giving the virtual gift, the more the virtual resources included in the virtual resource package generated by the second terminal.

In S1103, the second terminal displays the virtual resource package on the live-streaming page, wherein the virtual resource package is configured to, upon being triggered, display a target comment sent by the first audience user on the live-streaming page, and the first audience user is any audience user other than the second audience user in the virtual live-streaming room.

In the embodiments of the present disclosure, the second terminal displays the virtual resource package on the live-streaming page, such that the first audience user in the virtual live-streaming room can participates in the activity of receiving the virtual resource package by triggering the virtual resource package, and automatically sends a target comment in the virtual live-streaming room. Thus, the target comment sent by the first audience user are displayed on the live-streaming page. The target comment is described in the step S202 of the method illustrated in FIG. 2, and is not repeated herein.

In S1104, the second terminal displays a thank-you message on the live-streaming page of the virtual live-streaming room in the case that the number of target comment is greater than a quantity threshold. The thank-you message is identified as a message from the second audience user, and is a message configured to thank the first audience user who has sent the target comment.

In the case that the number of target comment is greater than the quantity threshold, it represents that the number of participants of the virtual resource package is greater than the quantity threshold. At this time, the second terminal triggers a mechanism for displaying messages of thanks configured to thank the first audience user. That is, the terminal displays the thank-you message on the live-streaming page. The thank-you message may be the same as the thank-you message in the steps S306 and S307 of the method described in FIG. 3, and are not repeated herein.

The embodiments of the present disclosure provide a page display method. According to this method, when the second audience user gives a virtual gift to the anchor user of the virtual live-streaming room, a virtual resource package associated with the virtual gift is generated based on the target virtual resource corresponding to the virtual gift, and the virtual resource package is displayed on the live-streaming page. In this way, after the first audience user triggers the virtual resource package, the second terminal can display the target comment automatically sent by the first audience user on the live-streaming page. The first audience user may be a plurality of audience users in the live-streaming room. Furthermore, when the number of target comments from the first audience user is greater than the quantity threshold, the second terminal can display a message of thanks for thanking the first audience user, thereby achieving more interaction between the audience users, which not only enriches the interaction mode between the audience users, but also simplifies the interaction path for receiving the virtual resource package. Thus, the participation efficiency of the audience users and the human-computer interaction efficiency are improved.

In some embodiments, the second audience user may continuously give a plurality of virtual gifts to the anchor user, and generate one virtual resource package based on the plurality of virtual gifts. Accordingly, in the case that the gift-giving operation is a continuous gift-giving operation, the second terminal determines the number of the plurality of virtual gifts continuously given by the second audience user when the prize draw countdown of the virtual resource package is not less than a preset duration. The continuous gift-giving operation indicates that the virtual gifts are continuously given and that the interval between times of giving the virtual gifts is not greater than a time duration threshold. The second terminal generates a virtual resource package associated with the plurality of virtual gifts based on the number of the plurality of virtual gifts and a target virtual resource corresponding to the plurality of virtual gifts. The target virtual resource is a virtual resource spent by the second audience user on sending any one of the plurality of virtual gifts, and the virtual resources included in the virtual resource package are positively correlated with the number of virtual gifts and the target virtual resource. The plurality of virtual gifts continuously given by the second audience user may be the same virtual gift or the same type of virtual gifts, and the same type of virtual gifts may be a series of gifts of the same type. After the second audience user gives a virtual gift to the anchor user, a virtual resource package associated with the virtual gift can be triggered. Moreover, if the second audience user continues to give the virtual gifts to the anchor user when the prize draw countdown of the virtual resource package is not less than a preset duration, the second terminal generates a virtual resource package associated with the plurality of virtual gifts based on the number of the plurality of virtual gifts consecutively given by the second audience user and the target virtual resource corresponding to the plurality of virtual gifts. Since the virtual resources included in the virtual resource package are positively correlated with the number of the plurality of virtual gifts and the target virtual resource, every time that the second audience user continuously gives a virtual gift, the virtual resources included in the virtual resource package increase, which increases the diversity of the contents in the virtual resource package, enhances the interestingness of the second audience user in giving the virtual gifts, and improves the gift-giving efficiency of the audience users. Thus, the interaction efficiency between the audience user and the anchor user is improved, and thus the human-computer interaction efficiency is improved.

In some embodiments, since there is an upper limit on the number of virtual gifts to be given, there is an upper limit on the virtual resources included in the virtual resource package. Accordingly, in the case that the number of the plurality of virtual gifts is not greater than the quantity threshold, the second terminal determines a sum value of a preset proportion of virtual resources in the target virtual resources corresponding to the plurality of virtual gifts as the virtual resources included in the virtual resource package. In the case that the number of the plurality of virtual gifts is greater than the quantity threshold, the second terminal determines a sum value of the preset proportion of virtual resources in the target virtual resources corresponding to the virtual gifts of the quantity threshold as the virtual resources included in the virtual resource package. The second terminal generates the virtual resource package based on the virtual resources included in the virtual resource package. When the number of virtual gifts is not greater than the quantity threshold, it indicates that the number of the virtual gifts given by the second audience user to the anchor user does not exceed the preset upper limit, i.e., the quantity threshold, and thus the second terminal can determine the preset proportion of the virtual resources in the virtual resources spent on sending one virtual gift as the virtual resources included in the virtual resource package triggered by sending one virtual gift. The preset proportion may be 10%, 20%, 30%, etc. When the second audience user sends a plurality of virtual gifts at one time, the second terminal determines the sum value of the preset proportion of virtual resources in the target virtual resources corresponding to the plurality of virtual gifts as the virtual resources included in the virtual resource package triggered by sending the plurality of virtual gifts. Conversely, when the number of virtual gifts is greater than the quantity threshold, it indicates that the number of the virtual gifts given by the second audience user to the anchor user exceeds the preset upper limit, and thus the second terminal needs to determine the upper limit on the virtual resources included in the virtual resource package associated with the virtual gifts, that is, the second terminal can determine the sum value of the preset proportion of virtual resources in the target virtual resources corresponding to the virtual gifts of the quantity threshold as the virtual resources included in the virtual resource package. The second terminal sets the upper limit of the virtual gifts to be given, when the number of gifts that have been given does not exceed the upper limit, every time when one virtual gift is given, the preset proportion of virtual resources are increased in the virtual resource package until the number of the virtual gifts that have been given reaches the upper limit, and at this time the virtual resource is no longer added to the virtual resource package. In this way, the diversity of the contents in the virtual resource package is increased, the interestingness of the second audience user in giving the virtual gifts is increased, and the gift-giving efficiency of the audience users is improved. Thus, the interaction efficiency between the audience user and the anchor user is improved, and thus the human-computer interaction efficiency is improved.

In some embodiments, in response to the gift-giving operation of the second audience user to the anchor user, the second terminal determines at least one virtual gift given by the second audience user when the prize draw countdown is less than a preset duration. The second terminal generates a virtual resource package associated with the at least one virtual gift based on the number of the at least one virtual gift and the target virtual resource corresponding to the at least one virtual gift. The virtual resources included in virtual resource package are positively correlated with the number and the target virtual resource. In response to the prize draw countdown being ended, the second terminal displays the virtual resource package associated with the at least one virtual gift on the liv-streaming page. After the second audience user gives the second virtual gift to the anchor user, other audience users in the virtual live-streaming room may trigger the virtual resource package associated with the second virtual gift, and the second terminal displays the prize draw countdown on the virtual resource package. When the prize draw countdown is less than the preset duration, if the second audience user continues to give the virtual gift to the anchor user, the second terminal may first determine at least one virtual gift given by the second audience user during this period of time. After the prize draw is over, the virtual resource package associated with the at least one virtual gift is displayed on the live-streaming page. By determining the virtual gifts given by the second audience user to the anchor user during the period of time in which the price draw countdown is less than the preset duration, the second terminal can display the virtual resource package associated with the virtual gifts after the prize draw is over. That is, the second terminal can generate a new virtual resource package based on the virtual gifts given during this period of time, which not only improves the gift-giving experience of the audience users, but also increases the frequency of displaying the virtual resource package. Thus, the efficiency of interaction between the audience users and the human-computer interaction efficiency are improved.

All of the above optional technical solutions may be combined in any manner to form the optional embodiments of the present disclosure, and details are not repeated herein.

FIG. 12 is a block diagram of a page display apparatus according to some embodiments. Referring to FIG. 12, the apparatus includes a first display unit 1201 and the first generation unit 1202.

The first display unit 1201 is configured to display, in a case that a second audience user gives a target virtual gift to an anchor user of a virtual live-streaming room, a virtual resource package associated with the target virtual gift on a live-streaming page of the virtual live-streaming room. The second audience user is any audience user other than the first audience user in the virtual live-streaming room, the target virtual gift is any one of a plurality of virtual gifts of the virtual live-streaming room, and the anchor user is shown on the live-streaming page.

The first generation unit 1202 is configured to generate a target comment in response to a trigger operation on the virtual resource package. The target comment includes an initial comment and user information of the second audience user, the initial comment is any comment in a comment library, and the comment library includes a plurality of comments having different contents.

The first display unit 1201 is further configured to display the target comment sent by the first audience user on the live-streaming page.

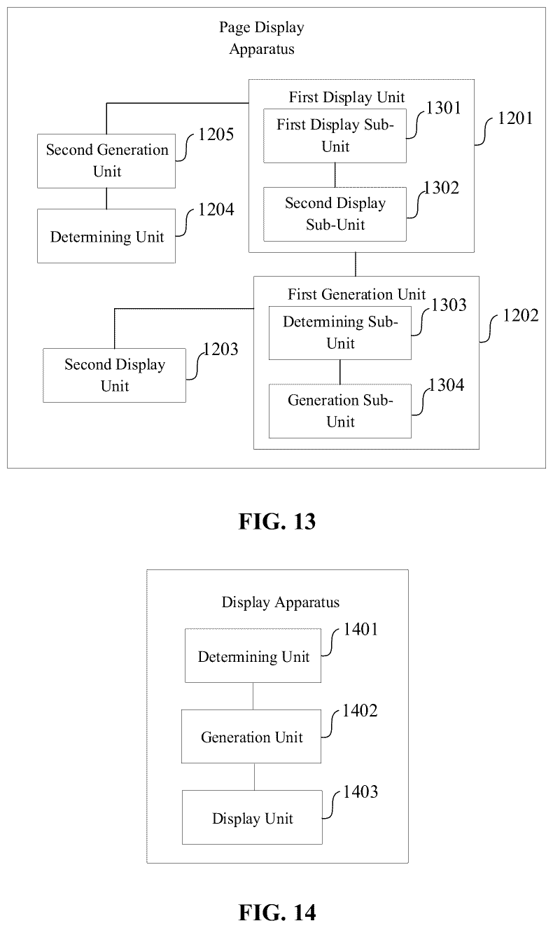

FIG. 13 is a block diagram of another page display apparatus according to some embodiments. Referring to FIG. 13, the first display unit 1201 includes:

a first display sub-unit 1301, configured to display a resource package entry of the virtual resource package on the live-streaming page of the virtual live-streaming room in the case that the second audience user gives the target virtual gift to the anchor user of the virtual live-streaming room; and
a second display sub-unit 1302, configured to display the virtual resource package on the live-streaming page in response to a trigger operation on the resource package entry, wherein the user information of the second audience user and a participation control are displayed on the virtual resource package, and the participation control is configured to, upon being triggered, display a number of participants of the virtual resource package and a prize draw countdown on the virtual resource package.

In some embodiments, still referring to FIG. 13, the first display unit 1201 includes:
a determining sub-unit 1303, configured to determine, in response to the trigger operation on the virtual resource package, a user type of the second audience user based on the user information of the second audience user, wherein the user type includes an anonymous type and a public type, the anonymous type indicates that the user information of the second audience user is displayed anonymously in the virtual live-streaming room, and the public type indicates that the user information of the second audience user is displayed publicly in the virtual live-streaming room; and
a generation sub-unit 1304, configured to generate the target comment based on anonymous information of the second audience user and the initial comment in the case that the user type is the anonymous type.

The generation sub-unit 1304 is further configured to generate the target comment based on a user name of the second audience user and the initial comment in the case that the user type is the public type.

In some embodiments, still referring to FIG. 13, the apparatus further includes:
a second display unit 1203, configured to display, in response to a number of participants of the virtual resource package being greater than a quantity threshold, a thank-you message with an anonymous type in a first display type on the live-streaming page in the case that the user type of the second audience user is the anonymous type, wherein the first display type is obtained based on at least one of live-streaming information of the virtual live-streaming room and relationship information of the second audience user, the relationship information represents an association relationship between the second audience user and the anchor user, and the anonymous type indicates that the user information of the second audience user is displayed anonymously in the virtual live-streaming room.

The second display unit 1203 is further configured to display a thank-you message with a public type in a second display type on the live-streaming page in the case that the user type of the second audience user is the public type, wherein the second display type is obtained based on the user information of the second audience user, and the public type indicates that the user information of the second audience user is displayed publicly in the virtual live-streaming room.

In some embodiments, the second display unit 1203 is further configured to display a first gift interface on the live-streaming page in response to a trigger operation on the thank-you message, wherein the plurality of virtual gifts and a first send control are displayed on the first gift interface, and the first send control is configured to, upon being triggered, send a virtual gift selected by the first audience user from the plurality of virtual gifts to the anchor user; and display the target virtual gift of the plurality of virtual gifts in a selected state.

In some embodiments, the second display unit 1203 is further configured to display a second gift interface on the live-streaming page in response to a trigger operation on the thank-you message, wherein gift details of the target virtual gift and a second send control are displayed on the second gift interface, and the second send control is configured to, upon being triggered, send the target virtual gift to the anchor user.

In some embodiments, still referring to FIG. 13, the apparatus further includes:
a determining unit 1204, configured to determine, in response to a gift-giving operation to the anchor user, a number of virtual gifts associated with the gift-giving operation and a target virtual resource, wherein the target virtual resource is a virtual resource spent by the first audience user on sending the virtual gifts; and
a second generation unit 1205, configured to generate the virtual resource package associated with the virtual gift based on the number of the virtual gifts and the target virtual resource, wherein an amount of virtual resources included in the virtual resource package are positively correlated with the number of the virtual gifts and an amount of the target virtual resource.

The first display unit 1201 is further configured to display the virtual resource package on the live-streaming page, wherein a number of participants of the virtual resource package and a prize draw countdown are displayed on the virtual resource package.

In some embodiments, the first display unit 1201 is further configured to display a resource package prompt message in the case that the first audience user is not in the virtual live-streaming room, wherein the resource package prompt message is used to prompt the first audience user that a virtual resource package is being distributed in the virtual live-streaming room; and display the live-streaming page of the virtual live-streaming room in response to a trigger operation on the resource package prompt message, wherein the virtual resource package is displayed on the live-streaming page.

The embodiments of the present disclosure provide a page display apparatus. When the second audience user gives the target virtual gift to the anchor user of the virtual live-streaming room, the virtual resource package associated with the target virtual gift is displayed on the live-streaming page. In this way, after the first audience user triggers the virtual resource package, the terminal can determine the target comment to be sent based on the user information of the second audience user and the initial comment, and automatically send the target comment to the virtual live-streaming room. The audience user can automatically comment by triggering the virtual resource package, thereby achieving efficient interaction between audience users, which not only enriches the interaction mode between the audience users, but also simplifies the interaction path for receiving the virtual resource package. Thus, the participation efficiency of the audience users and the human-computer interaction efficiency are improved. According to the present disclosure, the chain interaction among multiple people in the live-streaming room is triggered by way of gift-giving, which improves the interactive display effect and display time of gifts, which can prolong the interactive effect in the live-streaming room by using gifts in the manner of a secondary special effect of one-key gift-giving, triggering to generate the resource package, clicking on the resource package to trigger automatic comments, multiple people's commenting to trigger gifts, thereby increasing other users' participation in the post-path operation brought by the gift-giving operation while enriching and prolonging the display effect of gift-giving, which is not achievable by the existing gift-giving.

FIG. 14 is a block diagram of still another page display apparatus according to some embodiments. Referring to FIG. 14, the apparatus includes a determining unit 1401, a generation unit 1402, and a display unit 1403.

The determining unit 1401 is configured to determine, in response to a gift-giving operation of the second audience user to an anchor user of a virtual live-streaming room, a virtual gift associated with the gift-giving operation.

The generation unit 1402 is configured to generate a virtual resource package associated with the virtual gift based on a target virtual resource corresponding to the virtual gift. The target virtual resource is a virtual resource spent by the second audience user on sending the virtual gift, and an amount of virtual resources included in the virtual resource package are positively correlated with the target virtual resource.

The display unit 1403 is configured to display the virtual resource package on a live-streaming page of the virtual live-streaming room. The virtual resource package is configured to, upon being triggered, display a target comment sent by a first audience user on the live-streaming page, and the first audience user is any audience user other than the second audience user in the virtual live-streaming room.

The display unit 1403 is further configured to display a thank-you message on the live-streaming page in a case that a number of the target comments is greater than a quantity threshold.

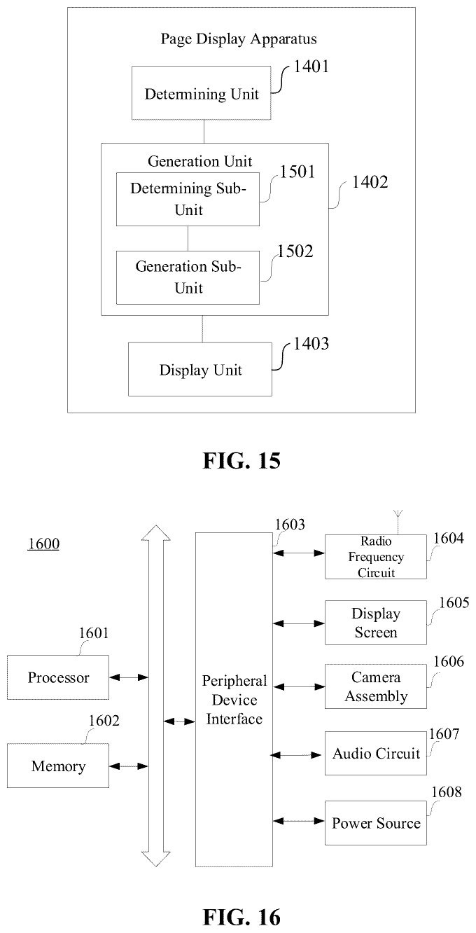

FIG. 15 is a block diagram of yet another page display apparatus according to some embodiments. As shown in FIG. 15, the generation unit 1402 includes:
a determining sub-unit 1501, configured to generate, in a case that the gift-giving operation is a continuous gift-giving operation, a number of a plurality of virtual gifts that are continuously given by the second audience user when a prize draw countdown is not less than a preset duration, wherein the continuous gift-giving operation indicates that the virtual gifts are continuously given and that an interval between times of giving the virtual gifts is not greater than a time duration threshold; and
a generation sub-unit 1502, configured to generate the virtual resource package associated with the plurality of virtual gifts based on the number of the plurality of virtual gifts and the target virtual resources corresponding to the plurality of virtual gifts, wherein the target virtual resource is a virtual resource spent by the second audience user on sending any one of the plurality of virtual gifts, and the an amount of virtual resources included in the virtual resource package are positively correlated with the number of the plurality of virtual gifts and an amount of the target virtual resource.

In some embodiments, the generation sub-unit 1502 is configured to determine a sum value of a preset proportion of virtual resources in the target virtual resources corresponding to the plurality of virtual gifts as the virtual resources included in the virtual resource package in the case that the number of the plurality of virtual gifts is not greater than a quantity threshold; determine a sum value of the preset proportion of virtual resources in the target virtual resources corresponding to the virtual gifts of the quantity threshold as the virtual resources included in the virtual resource package in the case that the number of the plurality of virtual gifts is greater than the quantity threshold; and generate the virtual resource package based on the virtual resources included in the virtual resource package.

In some embodiments, the determining unit 1401 is configured to determine, in response to the gift-giving operation of the second audience user to the anchor user, at least one virtual gift given by the second audience user when the prize draw countdown is less than the preset duration.

The generation unit 1402 is further configured to generate the virtual resource package associated with the at least one virtual gift based on the number of the at least one virtual gift and the target virtual resource corresponding to the at least one virtual gift, wherein an amount of virtual resources included in the virtual resource package are positively correlated with the number of the at least one virtual gift and an amount of the target virtual resource.

The display unit 1403 is further configured to display, in response to the prize draw countdown being ended, the virtual resource package associated with at least one virtual gift on the live-streaming page.

The embodiments of the present disclosure provide a page display apparatus. When the second audience user gives the virtual gift to the anchor user of the virtual live-streaming room, the virtual resource package associated with the virtual gift is generated based on the target virtual resource corresponding to the virtual gift and is displayed on the live-streaming page. In this way, after the first audience user triggers the virtual resource package, the second terminal can display the target comment automatically sent by the first audience user on the live-streaming page, and display the thank-you message for thanking the second audience user when the number of the target comments is greater than a quantity threshold, thereby achieving interaction between audience users, which not only enriches the interaction mode between the audience users, but also simplifies the interaction path for receiving the virtual resource package. Thus, the participation efficiency of the audience users and the human-computer interaction efficiency are improved.

It is to be noted that the page display apparatus provided in the above embodiments is only illustrated by way of example with the division of each of the above functional units, and in actual application, the above functions may be assigned to be completed by different functional units according to needs, i.e., the internal structure of the electronic device is divided into different functional units to complete all or part of the above-described functions. In addition, the page display apparatus provided in the above embodiments shares the same concept as the page display method embodiments, and for the specific implementation processes thereof, please refer to the method embodiments, which are not repeated herein.

With respect to the page display apparatus in the above embodiments, the specific manner in which each module performs an operation has been described in detail in the related method embodiments, and are not described herein in detail.

FIG. 16 is a block diagram of an electronic device according to some embodiments. Generally, the electronic device 1600 includes a processor 1601 and a memory 1602.

The processor 1601 includes one or more processing cores, such as a 4-core processor and an 8-core processor. The processor 1601 is implemented in at least one hardware form of a digital signal processor (DSP), a field programmable gate array (FPGA), and a programmable logic array (PLA). The processor 1601 also includes a main processor and a coprocessor. The main processor is a processor configured to process data in an awake state, and is also referred to as a central processing unit (CPU). The coprocessor is a low-power processor configured to process data in a standby state. In some embodiments, the processor 1601 is integrated with a graphics processing unit (GPU) that is responsible for rendering and drawing contents that need to be displayed on a display screen. In some other embodiments, the processor 1601 further includes an artificial intelligence (AI) processor for processing computing operations related to machine learning.

The memory 1602 includes one or more computer-readable storage media, which is non-transitory. The memory 1602 further includes a high-speed random access memory, and a non-volatile memory, such as one or more magnetic disk storage devices and flash storage devices. In some embodiments, a non-transitory computer-readable storage medium in the memory 1602 is configured to store at least one program code. The at least one program code is configured to be run by the processor 1601 to perform the page display method in the method embodiments.

In some embodiments, the electronic device 1600 further includes a peripheral device interface 1603 and at least one peripheral device. The processor 1601, the memory 1602, and the peripheral device interface 1603 are connected via buses or signal lines. The peripheral devices are connected to the peripheral device interface 1603 via a bus, signal line, or circuit board. The peripheral devices include at least one of a radio frequency circuit 1604, a display screen 1605, a camera assembly 1606, an audio circuit 1607, and a power source 1608.

The peripheral device interface 1603 is configured to connect at least one peripheral device associated with an input/output (I/O) to the processor 1601 and the memory 1602. In some embodiments, the processor 1601, the memory 1602, and the peripheral device interface 1603 are integrated on the same chip or circuit board. In some other embodiments, any one or two of the processor 1601, the memory 1602, and the peripheral device interface 1603 are implemented on a separate chip or circuit board, which is not limited in the embodiments of the present disclosure.

The radio frequency circuit 1604 is configured to receive and transmit a radio frequency (RF) signal, which is also referred to as an electromagnetic signal. The radio frequency circuit 1604 is communicated with a communication network and other communication devices via electromagnetic signals. The radio frequency circuit 1604 converts an electrical signal into an electromagnetic signal for transmission or converts a received electromagnetic signal into an electrical signal. In some embodiments, the radio frequency circuit 1604 includes an antenna system, an RF transceiver, one or more amplifiers, a tuner, an oscillator, a digital signal processor, a codec chipset, a subscriber identity module card, and the like. The radio frequency circuit 1604 is communicated with other terminals via at least one wireless communication protocol. The wireless communication protocol includes, but is not limited to, a metropolitan area network, various generations of mobile communication networks (2G, 3G, 4G, and 5G), a wireless local area network, and/or a wireless fidelity (Wi-Fi) network. In some embodiments, the radio frequency circuit 1604 further includes a near field communication (NFC) related circuit, which is not limited in the embodiments of the present disclosure.

The display screen 1605 is configured to display a user interface (UI). The UI includes graphics, text, icons, videos, and any combination thereof. In the case that the display screen 1605 is a touch display screen, the display screen 1605 also has the capacity to acquire a touch signal on or above a surface of the display screen 1605. The touch signal is input to the processor 1601 as a control signal for processing. In this case, the display screen 1605 is also configured to provide virtual buttons and/or virtual keyboards, which are also referred to as soft buttons and/or soft keyboards. In some embodiments, there is one display screen 1605 arranged on a front panel of the electronic device 1600; in some other embodiments, there are at least two display screens 1605 arranged on different surfaces of the electronic device 1600, respectively or in a folded design. In some still other embodiments, the display screen 1605 is a flexible display screen arranged on a curved surface or a folded surface of the electronic device 1600. Moreover, the display screen 1605 may have an irregular shape other than a rectangle, that is, an irregular-shaped screen. The display screen 1605 is prepared by using a material such as a liquid crystal display (LCD) or an organic light-emitting diode (OLED).

The camera assembly 1606 is configured to capture images or videos. In some embodiments, the camera component 1606 includes a front camera and a rear camera. Generally, the front camera is disposed on the front panel of the electronic device and the rear camera is disposed on a back side of the electronic device. In some embodiments, there are at least two rear cameras, and each of the at least two rear cameras is any one of a main camera, a depth-of-field camera, a wide-angle camera, and a telephoto camera, to realize a background blurring function realized by fusion of the main camera and the depth-of-field camera, panoramic shooting and virtual reality (VR) shooting functions by fusion of the main camera and the wide-angle camera, or other fusion shooting functions. In some embodiments, the camera component 1606 further includes a flash. The flash is a mono-color temperature flash or a two-color temperature flash. The two-color temperature flash is a combination of a warm-light flash and a cold-light flash, and can be used for light compensation at different color temperatures.

The audio circuit 1607 includes a microphone and a loudspeaker. The microphone is configured to acquire sound waves of the user and the environment, and convert the sound waves into electrical signals which are input into the processor 1601 for processing, or input into the radio frequency circuit 1604 for voice communication. For stereo collection or noise reduction, there are a plurality of microphones disposed at different parts of the electronic device 1900, respectively. The microphone is also an array microphone or an omnidirectional acquisition microphone. The loudspeaker is configured to convert the electrical signal from the processor 1601 or the radio frequency circuit 1604 into sound waves. The loudspeaker is a conventional film loudspeaker and is also a piezoelectric ceramic loudspeaker. In the case that the loudspeaker is a piezoelectric ceramic loudspeaker, the electrical signals can be converted into not only human-audible sound waves but also the sound waves that are inaudible to humans for ranging and the like. In some embodiments, the audio-frequency circuit 1607 further includes a headphone jack.

The power source 1608 is configured to supply power for various components in the electronic device 1600. The power source 1608 is an alternating current, a direct current, a disposable battery, or a rechargeable battery. In the case that the power source 1608 includes a rechargeable battery, the rechargeable battery is a wired charging battery or a wireless charging battery. The rechargeable battery also supports the fast charging technology.

Those skilled in the art can understand that the structure illustrated in FIG. 16 does not constitute a limitation of the electronic device 1600, and may include more or fewer components than illustrated, or a combination of certain components, or a different arrangement of components.

In some example embodiments, a computer-readable storage medium including instructions is further provided, such as a memory 1602 including instructions. The instructions, when executed by the processor 1601 of the electronic device 1600, are caused to perform the aforementioned page display method. In some embodiments, the computer-readable storage medium is a ROM, a random access memory (RAM), a CD-ROM, a magnetic tape, a floppy disk, an optical data storage device, and the like.

A computer program product is provided. The computer program product includes computer programs that, when executed by a processor, are caused to perform the aforementioned page display method.

Other embodiments of the present disclosure are apparent to those skilled in the art from consideration of the specification and practice of the present invention disclosed herein. The present disclosure is intended to cover any variations, uses, or adaptations of the present disclosure following the general principles of the present disclosure and including known common knowledge or customary technical means undisclosed in the art of the present disclosure. The specification and embodiments are provided for illustrative purposes only, and the true scope and spirit of the present disclosure are indicated by the following claims.

It should be understood that the present disclosure is not limited to the precise arrangements that have been described above and illustrated in the accompanying drawings, and that various modifications and changes can be made without departing from the scope thereof. The scope of the present disclosure is limited solely by the appended claims.

What is claimed is:

1. A page display method, performed by a first terminal on which a first audience user is currently logged in, the method comprising:
displaying, in a case that a second audience user gives a target virtual gift to an anchor user of a virtual live-streaming room, a first virtual resource package associated with the target virtual gift on a live-streaming page of the virtual live-streaming room, wherein the second audience user is any audience user other than the first audience user in the virtual live-streaming room, the target virtual gift is any one of a plurality of virtual gifts of the virtual live-streaming room, and the anchor user is shown on the live-streaming page;
generating a target comment in response to a trigger operation on the first virtual resource package, wherein the target comment comprises an initial comment and user information of the second audience user, the initial comment is any comment in a comment library, and the comment library comprises a plurality of comments having different contents; and
displaying the target comment sent by the first audience user on the live-streaming page, wherein the target comment is identified as a comment sent by the first audience user.

2. The page display method according to claim 1, wherein displaying, in the case that the second audience user gives the target virtual gift to the anchor user of the virtual live-streaming room, the first virtual resource package associated with the target virtual gift on the live-streaming page of the virtual live-streaming room, comprises:
displaying a resource package entry of the first virtual resource package on the live-streaming page of the virtual live-streaming room in the case that the second audience user gives the target virtual gift to the anchor user of the virtual live-streaming room; and
displaying the first virtual resource package on the live-streaming page in response to a trigger operation on the resource package entry, wherein the displayed first virtual resource package includes the user information of the second audience user and a participation control, and the participation control is configured to, upon being triggered, display a number of participants of the first virtual resource package and a prize draw countdown on the first virtual resource package.

3. The page display method according to claim 1, wherein generating the target comment in response to the trigger operation on the first virtual resource package comprises:
determining, in response to the trigger operation on the first virtual resource package, a user type of the second audience user based on the user information of the second audience user, wherein the user type comprises an anonymous type and a public type, the anonymous type indicates that the user information of the second audience user is displayed anonymously in the virtual live-streaming room, and the public type indicates that the user information of the second audience user is displayed publicly in the virtual live-streaming room;
generating the target comment based on anonymous information of the second audience user and the initial comment in a case that the user type is the anonymous type; and
generating the target comment based on a user name of the second audience user and the initial comment in a case that the user type is the public type.

4. The page display method according to claim 1, further comprising:
displaying, in response to a number of participants of the first virtual resource package being greater than a quantity threshold, a thank-you message with an anonymous type in a first display type on the live-streaming page in a case that a user type of the second audience user is the anonymous type, wherein the thank-you message is directed to the second audience user, and wherein the first display type is obtained based on at least one of live-streaming information of the virtual live-streaming room and relationship information of the second audience user, the relationship information represents an association relationship between the second audience user and the anchor user, and the anonymous type indicates that the user information of the second audience user is displayed anonymously in the virtual live-streaming room, wherein the thank-you message is a message from the message library; and
displaying a thank-you message with a public type in a second display type on the live-streaming page in a case that the user type of the second audience user is the public type, wherein the second display type is obtained based on the user information of the second audience user, and the public type indicates that the user information of the second audience user is displayed publicly in the virtual live-streaming room.

5. The page display method according to claim 4, further comprising:
displaying a first gift interface on the live-streaming page in response to a trigger operation on the thank-you message, wherein the plurality of virtual gifts and a first send control are displayed on the first gift interface, and the first send control is configured to, upon being triggered, send a virtual gift selected by the first audience user from the plurality of virtual gifts to the anchor user; and
displaying the plurality of virtual gifts, wherein the target virtual gift is displayed in a selected state.

6. The page display method according to claim 4, further comprising:
displaying a second gift interface on the live-streaming page in response to a trigger operation on the thank-you message, wherein gift details of the target virtual gift and a second send control are displayed on the second gift interface, and the second send control is configured to, upon being triggered, send the target virtual gift to the anchor user.

7. The page display method according to claim 1, further comprising:
determining, in response to a gift-giving operation of the first audience user to the anchor user, a number of virtual gifts associated with the gift-giving operation and a target virtual resource, wherein the target virtual resource is a virtual resource spent by the first audience user on sending the virtual gifts;
generating a second virtual resource package associated with the virtual gifts based on the number of the virtual gifts and the target virtual resource, wherein an amount of virtual resources included in the second virtual resource package are positively correlated with the number of the plurality of virtual gifts and an amount of the target virtual resource; and
displaying the second virtual resource package on the live-streaming page, wherein a number of participants of the second virtual resource package and a prize draw countdown are displayed on the second virtual resource package.

8. The page display method according to claim 1, further comprising:
displaying a resource package prompt message in a case that the first audience user is not in the virtual live-streaming room, wherein the resource package prompt message is used to prompt the first audience user that the first virtual resource package is being distributed in the virtual live-streaming room; and
displaying the live-streaming page of the virtual live-streaming room in response to a trigger operation on the resource package prompt message, wherein the first virtual resource package is displayed on the live-streaming page.

9. A page display method, performed by a second terminal on which a second audience user is currently logged in, the method comprising:
determining, in response to a gift-giving operation of the second audience user to an anchor user of a virtual live-streaming room, a virtual gift associated with the gift-giving operation;
generating a virtual resource package associated with the virtual gift based on a target virtual resource corresponding to the virtual gift, wherein the target virtual resource is a virtual resource spent by the second audience user on sending the virtual gift, and an amount of virtual resources included in the virtual resource package are positively correlated with the target virtual resource;
displaying the virtual resource package on a live-streaming page of the virtual live-streaming room, wherein the virtual resource package is configured to, upon being triggered, display a target comment sent by a first audience user on the live-streaming page, and the first audience user is any audience user other than the second audience user in the virtual live-streaming room; and
displaying a message of thanks on the live-streaming page in a case that a number of the target comment is greater than a quantity threshold, wherein the message of thanks is directed to the first audience user.

10. The page display method according to claim 9, wherein the target comment comprises an initial comment and user information of the second audience user, the initial comment is any comment in a comment library, and the comment library comprises a plurality of comments having different contents, and wherein the target comment is identified as a comment from the first audience user, and the target comment comprises a plurality of comments from a plurality of first audience users; and
generating the virtual resource package associated with the virtual gifts based on the target virtual resource corresponding to the virtual gift comprises:
determining, in a case that the gift-giving operation is a continuous gift-giving operation, a number of a plurality of virtual gifts that are continuously given by the second audience user when a prize draw countdown is not less than a preset duration, wherein the continuous gift-giving operation indicates that the virtual gifts are continuously given and that an interval between times of giving the virtual gifts is not greater than a time duration threshold; and
generating the virtual resource package associated with the plurality of virtual gifts based on the number of the plurality of virtual gifts and the target virtual resources corresponding to the plurality of virtual gifts, wherein the target virtual resource is a virtual resource spent by the second audience user on sending any one of the plurality of virtual gifts, and an amount of virtual resources included in the virtual resource package are positively correlated with the number of the plurality of virtual gifts and an amount of the target virtual resource.

11. The page display method according to claim 10, further comprising:
determining, in response to the gift-giving operation of the second audience user to the anchor user, at least one virtual gift given by the second audience user when the prize draw countdown is less than the preset duration;
generating a virtual resource package associated with the at least one virtual gift based on a number of the at least one virtual gift and the target virtual resource corresponding to the at least one virtual gift, wherein an amount of virtual resources included in the virtual resource package are positively correlated with the number of the at least one virtual gift and an amount of the target virtual resource; and
displaying, in response to the prize draw countdown being ended, the virtual resource package associated with the at least one virtual gift on the live-streaming page.

12. An electronic device on which a first audience user is currently logged in, comprising:
one or more processors; and
a memory configured to store program codes executable by the one or more processors;
wherein the one or more processors are configured to execute the program codes to implement the method according to claim 1.

13. An electronic device on which a second audience user is currently logged in, comprising:
one or more processors; and
a memory configured to store program codes executable by the one or more processors;
wherein the one or more processors are configured to execute the program codes to implement the method according to claim 9.
